(19) United States
(12) Patent Application Publication
(10) Pub. No.: US 2024/0290343 A1
(43) Pub. Date: Aug. 29, 2024

(54) METHODS AND APPARATUS FOR REAL-TIME VOICE TYPE DETECTION IN AUDIO DATA

(71) Applicant: Intel Corporation, Santa Clara, CA (US)

(72) Inventors: Hector Alfonso Cordourier Maruri, Guadalajara (MX); Himanshu Bhalla, Bengaluru (IN); Georg Stemmer, Munich (DE); Sinem Aslan, Portland, OR (US); Julio Cesar Zamora, West Sacramento, CA (US); Jose Rodrigo Camacho Perez, Guadalajara (MX); Paulo Lopez Meyer, Guadalajara (MX); Alejandro Ibarra Von Borstel, Manchaca, TX (US); Jose Israel Torres Ortega, Zapopan (MX); Juan Antonio Del Hoyo Ontiveros, Tlajomulco (MX)

(21) Appl. No.: 18/176,252

(22) Filed: Feb. 28, 2023

(51) Int. Cl. G10L 25/30; G06N 3/0499; G10L 15/06; G10L 25/12

(52) U.S. Cl. CPC G10L 25/30; G06N 3/0499; G10L 15/063; G10L 25/12; G10L 2015/0635

(57) ABSTRACT

Methods, apparatus, systems, and articles of manufacture for real-time voice type detection in audio data are disclosed. An example non-transitory computer-readable medium disclosed herein includes instructions, which when executed, cause one or more processors to at least identify a first vocal effort of a first audio segment of first audio data and a second vocal effort of a second audio segment of the first audio data, train a neural network including training data, the training data including the first vocal effort, the first audio segment, the second audio segment, and the second vocal effort, and deploy the neural network, the neural network to distinguish between the first vocal effort and the second vocal effort.

### FIELD OF THE DISCLOSURE

This disclosure relates generally to audio analysis and, more particularly, to methods and apparatus for real-time voice type detection in audio data.

### BACKGROUND

During human communication, people can use different vocal efforts (e.g., depending on the context, types of conversations, etc.). Normally, speakers use a regular voice type, but different environmental or emotional stressing conditions can cause a person to change to another voice type (concern of being overheard, having a heated argument, too much background noise, etc.).

### BRIEF DESCRIPTION OF THE DRAWINGS

FIG. 1 is a schematic illustration of an example vocal effort detection system implemented in accordance with the teachings of this disclosure.

FIG. 2 is a block diagram of the model generator circuitry of FIG. 1.

FIG. 3 is a block diagram of the audio processor circuitry of FIG. 1.

FIG. 4 is a schematic illustration of an example output of the vocal detection system of FIG. 1.

FIG. 5 is a schematic illustration of another example implementation of the audio processor circuitry of FIG. 1.

FIG. 6 depicts spectrograms of speech with regular voice effort, soft voice effort, and whispered voice effort.

FIG. 7 depicts a summary of potential results of an example audio processor circuitry of FIGS. 1 and 3.

FIG. 8 is a flowchart representative of example machine readable instructions and/or example operations that may be executed by example processor circuitry to implement the model generator circuitry of FIG. 2.

FIG. 9 is a flowchart representative of example machine readable instructions and/or example operations that may be executed by example processor circuitry to implement the audio processor circuitry of FIG. 3.

FIG. 10 is a block diagram of an example processing platform including processor circuitry structured to execute the example machine readable instructions and/or the example operations of FIG. 8 to implement the model generator circuitry of FIG. 2.

FIG. 11 is a block diagram of an example processing platform including processor circuitry structured to execute the example machine readable instructions and/or the example operations of FIG. 9 to implement the audio processor circuitry of FIG. 3.

FIG. 12 is a block diagram of an example implementation of the processor circuitry of FIG. 10 and/or the processor circuitry of FIG. 11.

FIG. 13 is a block diagram of another example implementation of the processor circuitry of FIG. 10 and/or the processor circuitry of FIG. 11.

In general, the same reference numbers will be used throughout the drawing(s) and accompanying written description to refer to the same or like parts. The figures are not to scale.

### DETAILED DESCRIPTION

Automatically detecting the voice type and labeling such types as metadata can enable multiple capabilities, from voice enhancement (adjusting or transforming voice types with lower intelligibility) to emotion/user context detection. Lightweight machine learning, neural net-based systems to detect different voice types in real-time, and related methods are disclosed herein. These systems use linear predictive coding (LPC) coefficients as input features enabling the system to produce as output the voice type based on the vocal effort. In some examples disclosed herein, the use of LPCS reduces the computational costs of operating the neural network compared to other input features. In some examples disclosed herein, LPC coefficients indicate the tonal presence of voice, which enables the system to distinguish between different vocal efforts, such as soft vocal effort and whispered vocal efforts. In some examples described herein, the system outputs metadata, which has many different applications, such as punctuation in speech-to-text, context identification in speech-to-text, etc.

Systems, methods, apparatus, and articles of manufacture described herein enable the automated real-time identification of different voice types in captured audio. As used herein, the term “voice type” refers to a characterization of a person's speech based on voice characteristics that result from the vocal effort exerted in generating that speech. As used herein, the terms “voice type” and “vocal effort classification” are used interchangeably. As used herein, the term “vocal effort” is a quantity that corresponds to a perceived amount of vocal loudness and strain used by a speaker. Speakers generally use greater vocal effort when trying to speak in environments with a large amount of ambient noise, when speaking to someone far away, when speaking to a large group of people, when in a state of great emotional investment, and/or when attempting to get one or more listener(s) attention. Speakers generally use comparatively less vocal effort when speaking to someone close by, when trying to conceal their speech from potential eavesdroppers, when trying not to disturb surrounding persons, when in environments with low amounts of ambient noise, and/or when the speaker is calm.

Examples disclosed herein generally refer to five different voice types, namely, in order of most vocal effort to least vocal effort, (1) the yelled voice type, (2) the loud voice type, (3) the regular voice type, (4) the soft voice type, and (5) the whispered voice type. It should be appreciated that vocal efforts can be divided into different numbers of classifications (e.g., regular, above-regular, and below-regular, etc.) as needed for analysis. However, a vocal classification system may include any number or types of voice types.

The example regular voice type corresponds to speech delivered with regular vocal effort. The regular voice type is characterized by speech produced during normal conversations, typically in the absence of environmental or emotional stressing conditions on the speaker. The regular voice type has normal amplitude and pitch. The yelled voice type (e.g., the shouted voice type, the yelled vocal effort classification, etc.) corresponds to speech delivered with a yelled vocal effort.

The example yelled voice type is characterized by speech produced at high amplitude and pitch. The yelled voice type is typically used by people who perceive a high level of ambient noise (e.g., background noise, etc.) and/or people in high states of emotional investment (e.g., a speaker is experiencing great joy, a speaker is experiencing great anger, a speaker is in pain, a speaker is surprised, etc.).

The example loud voice type (e.g., the loud vocal effort classification, etc.) corresponds to a speech delivered with a loud vocal effort. The loud voice type is characterized by speech produced with substantially higher amplitude and slightly higher pitch than the regular voice type and can be associated with the speaker perceiving high amounts of background noise (e.g., the Lombard effect, etc.). The loud voice type can also be associated with a speaker being heavily invested in the conversation content (e.g., responding to a funny story, speaking from a position of authority, speaking during a heated argument, etc.). The loud voice type has comparatively lower amplitude and pitch than the yelled voice type.

The example soft voice type corresponds to speech delivered with a soft vocal effort. The soft voice type is characterized by speech produced with phonation (e.g., pitch, tone, harmonic variation, etc.), but with clear speaker-intended lower amplitude and lower pitch than speech in the regular voice type. The soft voice type is generally used by people to prevent others from eavesdropping, to not disturb nearby persons, and/or speech said to calm a listener.

The example whispered voice type corresponds to speech delivered with a whispered vocal effort. Unlike the soft voice type, the whispered voice type is characterized by speech produced without phonation and very low amplitude (e.g., minimum loudness, etc.) The use of the whispered voice type by a speaker implies a strong desire to not disturb other nearby people and/or a desire not to be overheard by potential eavesdroppers.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description. As used herein “substantially real-time” refers to occurrence in a near instantaneous manner recognizing there may be real world delays for computing time, transmission, etc. Thus, unless otherwise specified, “substantially real-time” refers to real-time+/−1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmable with instructions to perform specific operations and including one or more semiconductor-based logic devices (e.g., electrical hardware implemented by one or more transistors). Examples of processor circuitry include programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of processor circuitry is/are best suited to execute the computing task(s).

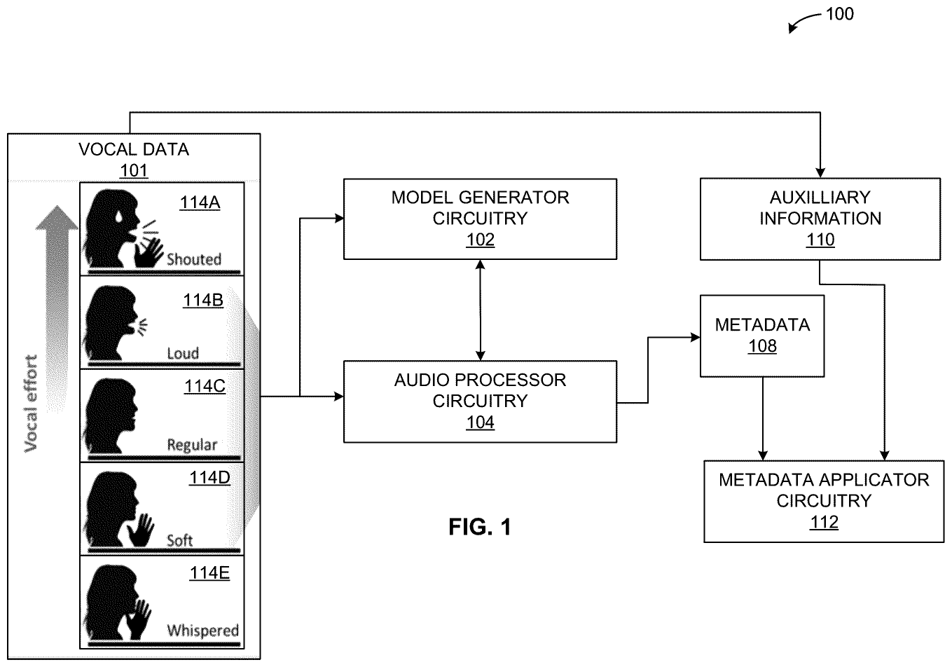

FIG. 1 is a schematic illustration of an example vocal effort detection system 100 implemented in accordance with the teachings of this disclosure. In the illustrated example of FIG. 1, the example vocal effort detection system 100 includes example model generator circuitry 102 and example audio processor circuitry 104, which analyze example vocal data 101 to generate example metadata 108. In the illustrated example of FIG. 1, the example metadata 108 and example auxiliary information 110 is used by an example metadata applicator circuitry 112.

In the illustrated example of FIG. 1, the vocal effort detection system 100 accesses (e.g., collects, receives, generates, etc.) the vocal data 101. The vocal data 101 includes audio containing speech. In some examples, the vocal data 101 can be live-captured audio (e.g., audio captured via a microphone, etc.). For example, the vocal data 101 can be audio from a business meeting, a public speech, a lecture, a dramatic production, etc. In some such examples, the vocal data 101 can correspond to the audio portion of captured multimedia information. In some examples, the vocal data 101 can be processed by the audio processor circuitry 104 in substantially real-time. Additionally or alternatively, the vocal data 101 can be stored (e.g., digitally stored, physically stored, etc.) information in a database, which can be accessed by the audio processor circuitry 104 to be processed. For example, the vocal data 101 can correspond to any recorded live-captured event and/or other media (e.g., recorded music, movies, television programming, historical recordings, commercials, etc.).

The vocal data 101 includes digitalized speech that includes audio segments that can be categorized as one or more of an example first vocal effort classification 114A, an example second vocal effort classification 114B, an example third vocal effort classification 114C, example fourth vocal effort classification 114D, and an example fifth vocal effort classification 114E. In some examples, the vocal effort classifications 114A, 114B, 114C, 114D, 114E correspond to different voice types that can be used by speakers during human communication depending on the context of the speech, the intent of the speaker, and the emotion of the speaker.

In the illustrated example of FIG. 1, the first vocal effort classification 114A corresponds to a “shouted” vocal effort (e.g., “yelled” vocal effort, etc.). In some such examples, the first vocal effort classification 114A is categorized by speech produced at the highest amplitude and pitch possible and can be associated with a speaker's perception of very high levels of background noise, or by a very high emotional investment (e.g., a speaker is experiencing great joy, a speaker is experiencing great anger, a speaker is in pain, a speaker is surprised, etc.). In the illustrated example of FIG. 1, the second vocal effort classification 114B corresponds to a “loud” vocal effort. In some such examples, the second vocal effort classification 114B is categorized by speech produced at the produced with substantially higher amplitude and slightly higher pitch than regular speech (e.g., speech in the third vocal effort classification 114C, etc.) and can be associated with the speaker perceiving high amounts of background noise (e.g., the Lombard effect, etc.). Additionally or alternatively, speech in the second vocal effort classification 114B can be categorized by a speaker being heavily invested in the conversation content (e.g., responding to a funny story, speaking from a position of authority, speaking during a heated argument, etc.).

In the illustrated example of FIG. 1, the third vocal effort classification 114C corresponds to a “regular” vocal effort. In some such examples, the third vocal effort classification 114C corresponds to speech produced during a normal conversation, without environmental or emotional stressing conditions. In some examples, speech within the third vocal effort classification 114C is characterized by a normal speaking amplitude and pitch. In the illustrated example of FIG. 1, the fourth vocal effort classification 114D corresponds to a “soft” vocal effort. In some such examples, the fourth vocal effort classification 114D corresponds to speech produced with phonation (e.g., pitch, tone, harmonic variation, etc.), but with clear speaker-intended lower amplitude and lower pitch than speech in the third vocal effort classification 114C. In some examples, speech within the fourth vocal effort classification 114D is associated with speech that is spoken in a manner to prevent others from eavesdropping, to not disturb nearby persons, and/or speech said to calm a listener. In the illustrated example of FIG. 1, the fifth vocal effort classification 114E corresponds to a “whispered” vocal effort. In some such examples, the fifth vocal effort classification 114E is categorized by speech produced without phonation, very low (e.g., minimum, etc.) amplitude (e.g., loudness, etc.). In some such examples, the speech in the fifth vocal effort classification 114E implies a strong desire by the speaker not to disturb others and/or be overheard.

Accordingly, in the illustrated example of FIG. 1, the first vocal effort classification 114A corresponds to speech with a greater vocal effort than the vocal effort classifications 114B, 114C, 114D, 114E. The second vocal effort classification 114B corresponds to speech with a greater vocal effort than the vocal effort classifications 114C, 114D, 114E. The third vocal effort classification 114C corresponds to speech with a greater vocal effort than the vocal effort classifications 114D, 114E. The fourth vocal effort classification 114D corresponds to speech with a greater vocal effort than the vocal effort classification 114E. In other examples, the vocal effort classifications 114A, 114B, 114C, 114D, 114E can correspond to any other suitable vocal efforts.

The example model generator circuitry 102 generates a model to be used by the audio processor circuitry 104 to classify the vocal data 101. In some examples, a portion of the vocal data 101 can be accessed, labeled by a technician according to the vocal effort(s) associated with the speech of the vocal data 101 (e.g., labeled as one or more of the vocal effort classifications 114A, 114B, 114C, 114D, 114E, etc.), and used to train a neural network via supervised learning to classify vocal data 101 according to the vocal effort(s) of the vocal data 101. In other examples, the model generator circuitry 102 can generate a neural network model via any other suitable method (e.g., unsupervised learning, etc.). In some such examples, the neural network generated by the model generator circuitry 102 and utilized by the audio processor circuitry 104 can be implemented by a multi-layered (e.g., a three-layered, etc.) feedforward neural network. In other examples, the model generator circuitry 102 can generate any other suitable type of neural network (e.g., a recurrent neural network (RNN), a long short-term memory (LSTM) network, etc.).

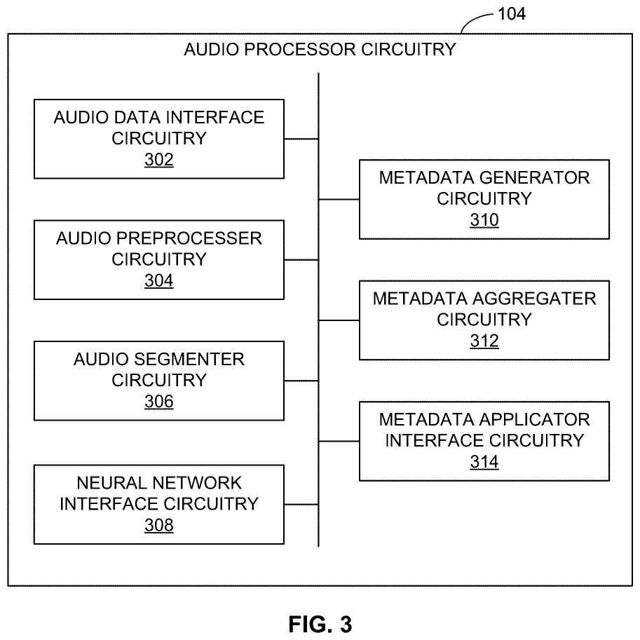

The example audio processor circuitry 104 classifies some or all of the vocal data 101 based on vocal effort. For example, the audio processor circuitry 104 can segment the vocal data 101 into a plurality of audio segments (e.g., a plurality of one-second audio segments, a plurality of two-second audio segments, a plurality of five-second audio segments, a plurality of different length audio segments, etc.) and analyze each of the segments to determine the vocal effort associated with the speech of that segment. For example, the audio processor circuitry 104 can classify the speech associated with some or all of the audio segments to determine if the speech within those audio segments falls within one or more of the vocal effort classifications 114A, 114B, 114C, 114D, 114E. In some examples, the audio processor circuitry 104 can use the neural network generated by the model generator circuitry 102 to classify the vocal data 101. An example implementation of the audio processor circuitry 104 is described below in conjunction with FIG. 3.

The example metadata 108 includes information relating to the vocal effort detected in various portions. In some examples, the metadata 108 can be a data structure that includes a timestamp (e.g., corresponding to a specific time or period within the vocal data 101, etc.) and a vocal effort classification associated with the speech of the vocal data 101 at that timestamp. In some such examples, the timestamps of the metadata 108 can correspond to the audio segments created by the audio processor circuitry 104 during the analysis of the vocal data 101. In some such examples, the vocal effort classification(s) of the metadata can be an integer value corresponding to one of the vocal effort classifications 114A, 114B, 114C, 114D, 114E (e.g., a value of “1” corresponding to the first vocal effort classification 114A, a value of “2” corresponding to the second vocal effort classification 114B, a value of “3” corresponding to the third vocal effort classification 114C, a value of “4” corresponding to the fourth vocal effort classification 114D, a value of “5” corresponding to the fifth vocal effort classification 114E, etc.). In other examples, the metadata 108 can be formatted in any other suitable data structure(s).

The auxiliary information 110 includes other information that can be used by the metadata applicator. In some examples, the auxiliary information can include video information associated with the vocal data 101, speech-to-text information generated by processing the vocal data 101, and/or information required to determine the context and/or emotion of the speech associated with the vocal data 101. In other examples, the auxiliary information 110 can include any other information.

The metadata applicator circuitry 112 applies the metadata 108 to augment the use of the vocal data 101. For example, the metadata applicator circuitry 112 can annotate speech-to-text output associated with the vocal data 101 with the detected vocal effort. In some examples, the metadata applicator circuitry 112 can annotate a speech-to-text output associated with the vocal data 101 with appropriate punctuation (e.g., adding exclamation points to speech with the first vocal effort classification 114A and/or the second vocal effort classification, capitalizing all letters in the text associated with speech in the first vocal effort classification 114A, putting speech identified in the fifth vocal effort classification 114E in parentheses, etc.). In some examples, the metadata applicator circuitry 112 can detect emotion and/or speaker investment via the metadata 108. In some examples, the metadata applicator circuitry 112 can enhance the sound quality of the vocal data using the metadata 108 (e.g., signal enhancement, noise reduction, etc.). In some examples, the metadata applicator circuitry 112 can augment the vocal data using the metadata 108 and enhancement/transformation algorithms depending on the detected vocal effects. In some examples, the metadata 108 can determine if an external stressing condition (e.g., a source that causes a speaker to speak loudly, etc.) is presented based on the metadata 108 is presented.

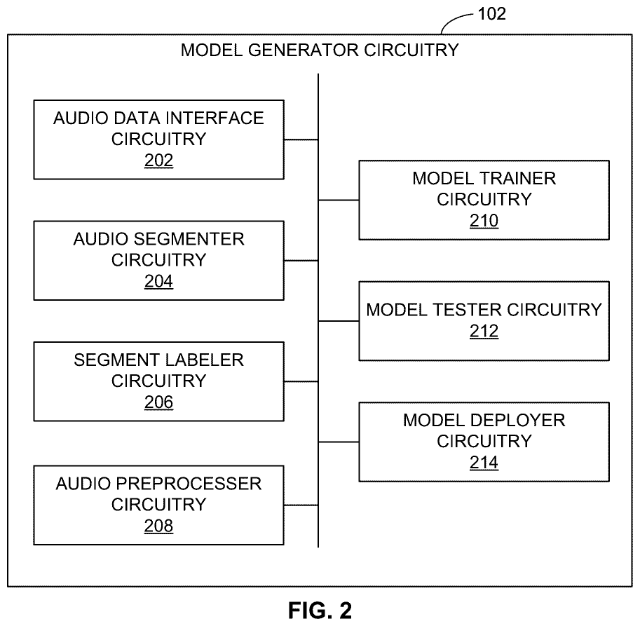

FIG. 2 is a block diagram of an example implementation the model generator circuitry 102 to do generate a neural network mode to identify the vocal effort(s) of audio. In the illustrated example of FIG. 2, the model generator circuitry 102 includes example audio data interface circuitry interface 202, example audio segmenter circuitry 204, example segment labeler circuitry 206, example audio preprocessor circuitry 208, example model trainer circuitry 210, example model tester circuitry 212, and example model deployer circuitry 214. The model generator circuitry 102 of FIG. 2 may be instantiated (e.g., creating an instance of, bring into being for any length of time, materialize, implement, etc.) by processor circuitry such as a central processing unit executing instructions. Additionally or alternatively, the model generator circuitry 102 of FIG. 2 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 2 may, thus, be instantiated at the same or different times. Some or all of the circuitry may be instantiated, for example, in one or more threads executing concurrently on hardware and/or in series on hardware. Moreover, in some examples, some or all of the circuitry of FIG. 2 may be implemented by microprocessor circuitry executing instructions to implement one or more virtual machines and/or containers.

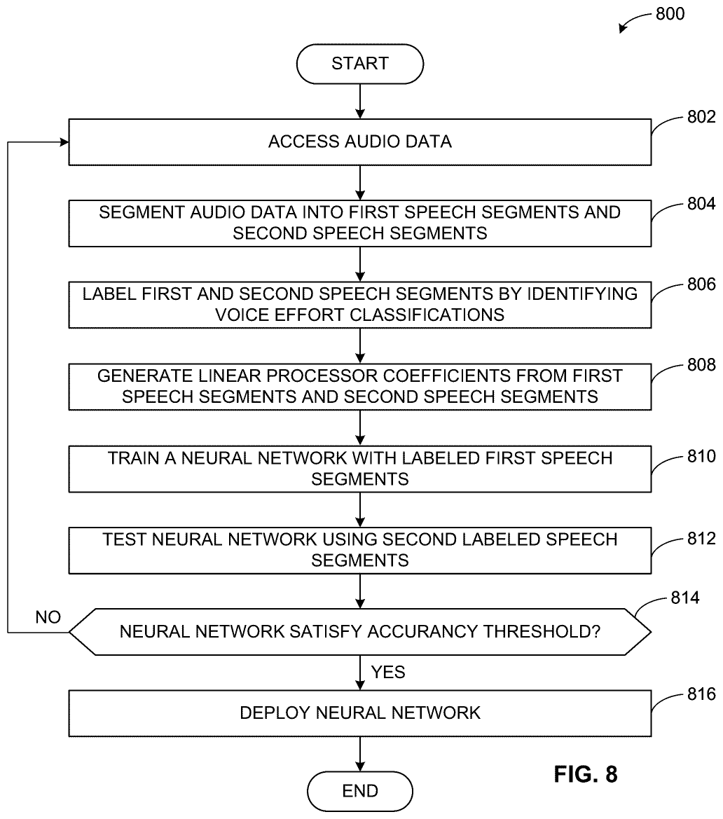

The audio data interface circuitry 202 of the illustrated example accesses audio data from a microphone, an audio database, and/or another source of audio. For example, the audio data interface circuitry 202 can access live-captured audio data (e.g., captured via one or more microphones associated with the model generator circuitry 102, etc.). In some examples, the audio data interface circuitry 202 can access recorded media (e.g., from a local database, from an online database, etc.). In some such examples, the accessed media can be associated with recorded entertainment media (e.g., television programs, movies, etc.), informative media (e.g., speeches, lectures, etc.), commercial media (e.g., advertisements, etc.), and/or other media (e.g., recorded business meetings, etc.). In some examples, the accessed audio data can be generated specifically to train a vocal effort neural network (e.g., via solicitation by a technician generating the neural network, via sampling recorded audio, etc.). In some examples, the audio data interface circuitry 202 is instantiated by processor circuitry executing audio data interface instructions and/or configured to perform operations such as those represented by the flowchart of FIG. 8.

The example audio segmenter circuitry 204 segments the accessed audio data into audio segments. For example, the audio segmenter circuitry 204 can segment the accessed audio data into a plurality of discrete audio segments. In some examples, the audio segmenter circuitry 204 can generate a plurality of audio segments of equal duration (e.g., 100-millisecond segments, 500-millisecond segments, one-second segments, three-second segments, etc.). In other examples, the audio segmenter circuitry 204 can generate a plurality of audio segments of non-equal durations. In other examples, the audio segmenter circuitry 204 can divide the accessed audio data into any other suitable segments. In some examples, the audio segmenter circuitry 204 can generate segments that overlap temporally adjacent audio segments. In some examples, the audio segmenter circuitry 204 can divide the audio data segments into first audio data segments, corresponding to audio segments to be used to train a neural network, and second audio data segments, corresponding to be used to test the trained neural network. In some examples, the audio segmenter circuitry 204 is instantiated by processor circuitry executing audio segmenter instructions and/or configured to perform operations such as those represented by the flowchart of FIG. 8.

The example segment labeler circuitry 206 labels the segmented audio data based on the vocal effort associated with the speech within the audio segments. For example, the segment labeler circuitry 206 can present the audio data segments to a technician (e.g., a user, etc.) and prompt the user to identify the vocal effort classification(s) of the presented audio data segments. In other examples, the segment labeler circuitry 206 can label the first and second audio data segments via audio analysis (e.g., analysis of the tone, pitch, harmonics, etc.). In some examples, the segment labeler circuitry 206 can present the labels generated via audio analysis to a technician for verification. In some examples, the segment labeler circuitry 206 can label each one of the first and second audio data segments with a corresponding vocal effort classification (e.g., one or the vocal effort classifications 114A, 114B, 114C, 114D, 114E of FIG. 1, etc.). Additionally or alternatively, the segmenter labeler circuitry 206 can label the audio segments via any other suitable technique. In some examples, the segmenter labeler circuitry 206 is instantiated by processor circuitry executing segment labeler instructions and/or configured to perform operations such as those represented by the flowchart of FIG. 8.

The audio preprocessor circuitry 208 of the illustrated example preprocesses the audio data for training and/or evaluating a neural network. For example, the audio preprocessor circuitry 208 can generate linear prediction coding (LPC) coefficients from the first audio segments and second audio segments. In some examples, the audio preprocessor circuitry 208 can use LPC processing techniques to generate LPC coefficients. In some examples, the audio preprocessor circuitry 208 can generate LPC coefficient vectors including 24 frequency bins (e.g., 24 elements, etc.). In other examples, the audio preprocessor circuitry 208 can generate LPC coefficients of any suitable size/quantity (e.g., 128 elements, 12 elements, 48 elements, etc.). In some examples, the audio preprocessor circuitry 208 can inverse filter the audio data to estimate the frequency and intensity of the audio data. In some such examples, the residue of the audio data can be filtered and used to synthesize the LPC coefficients. Additionally or alternatively, the audio preprocessor circuitry 208 can preprocess the audio data via any other audio processing techniques, including fast Fourier transforms (FFT) and/or Walsh-Hadamard transforms. In some examples, the audio preprocessor circuitry 208 is instantiated by processor circuitry executing audio preprocessor instructions and/or configured to perform operations such as those represented by the flowchart of FIG. 8.

The example model trainer circuitry 210 trains a neural network using the labeled and preprocessed audio segments. For example, the model trainer circuitry 210 can train a neural network using some of the labeled audio segments via supervised learning. In some such examples, the model trainer circuitry 210 can use any suitable supervised learning method (e.g., support-vector machine, linear regressions, logistic regression, discriminant function analysis, decision tree learning, etc.). In some examples, the model trainer circuitry 210 can train a three-layered neural network, feedforward, and fully connected. In other examples, the neural network trained by the model trainer circuitry 210 can be another type of neural network (e.g., a recurrent neural network (RNN), a long short-term memory (LSTM) neural network, etc.). In other examples, the model trainer circuitry 210 can train the neural network in any other suitable training technique, including unsupervised learning. In some examples, the model trainer circuitry 210 is instantiated by processor circuitry executing model trainer instructions and/or configured to perform operations such as those represented by the flowchart of FIG. 8.

The example model tester circuitry 212 tests the neural network using other ones of the labeled audio segments (e.g., labeled audio segments not used to train the neural network, etc.). For example, the model tester circuitry 212 can input preprocessed and labeled audio segments into the trained neural network, generated by the model trainer circuitry 210, record the output of the neural network, and compare the trained neural network to labels of the audio segments. In some such examples, the model tester circuitry 212 can generate accuracy statistics (e.g., a percentage of outputs of the neural network that match the corresponding label generated by the segment labeler circuitry 206, etc.). In other examples, the model tester circuitry 212 can test the generated neural network in any other suitable manner. In some examples, the model tester circuitry 212 can compare the accuracy statistics generated by the model tester circuitry 212 to a preset accuracy threshold. In some such examples, the accuracy threshold can be any suitable value (e.g., 75%, 90%, 99%, etc.). In other examples, the model tester circuitry 212 can determine if the generated neural network is sufficiently accurate in any other suitable manner. In some examples, if the model tester circuitry 212 determines the neural network does not satisfy an accuracy threshold, the model tester circuitry 212 can cause the model trainer circuitry 210 to train the neural network on additional labeled audio segments. In some examples, the model tester circuitry 212 is instantiated by processor circuitry executing model tester instructions and/or configured to perform operations such as those represented by the flowchart of FIG. 8.

The example model deployer circuitry 214 deploys the neural network. For example, the model deployer circuitry 214 can transmit the neural network to the audio processor circuitry 104. Additionally or alternatively, the model deployer circuitry 214 can publish the neural network to the cloud platform, an edge platform, and/or another suitable platform. In other examples, the model deployer circuitry 214 can deploy the neural network in any other suitable manner. In some examples, the audio data interface circuitry 202 is instantiated by processor circuitry executing model deployer instructions and/or configured to perform operations such as those represented by the flowchart of FIG. 8.

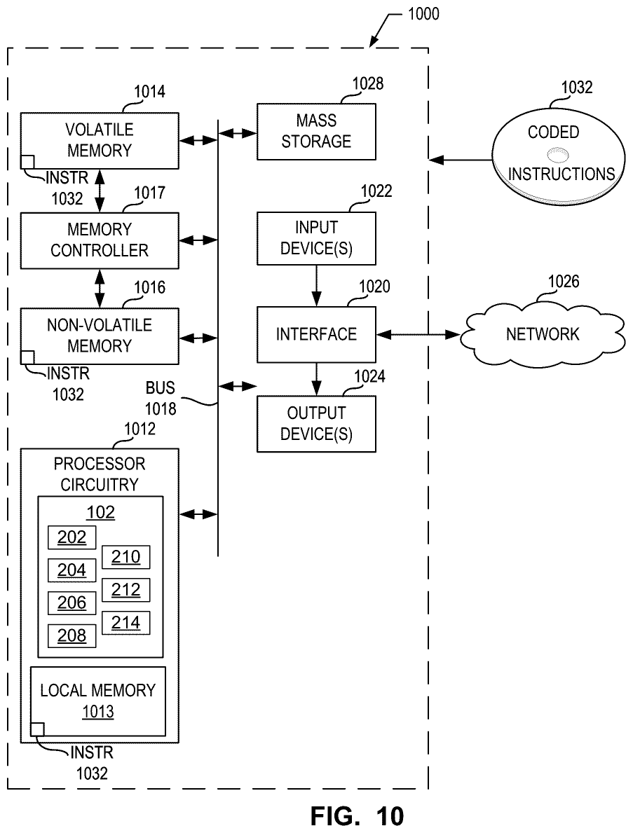

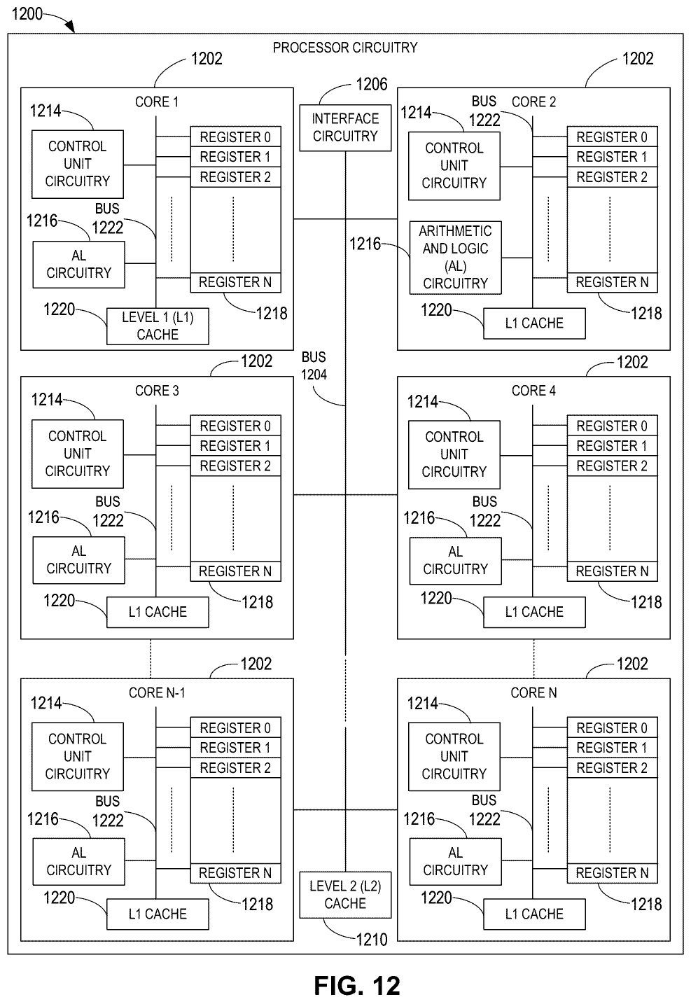

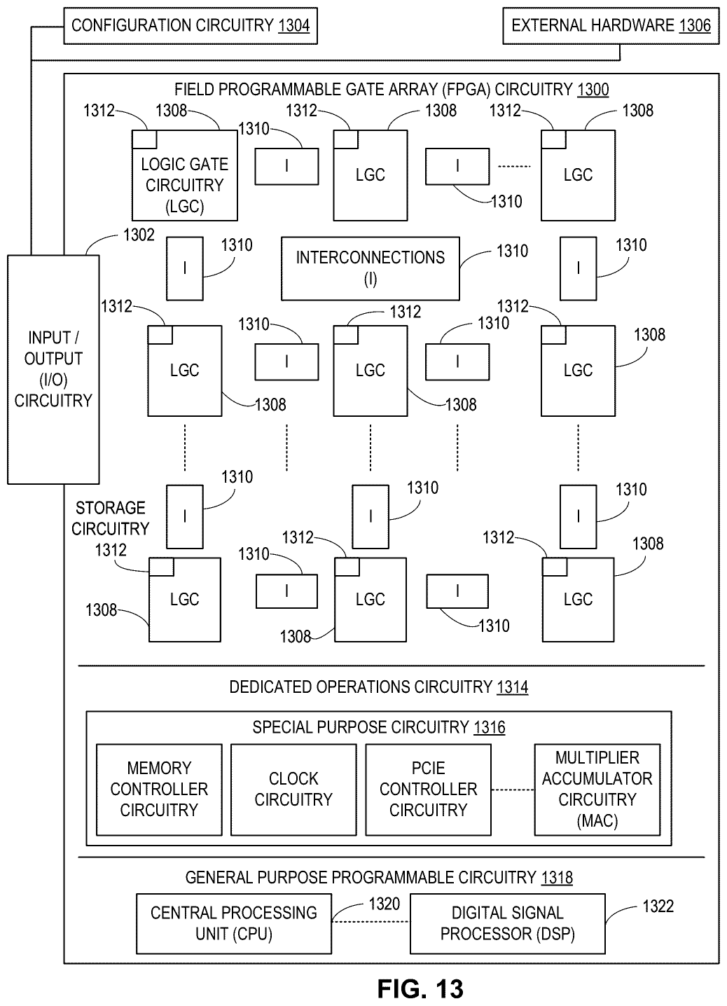

In some examples, the model generator circuitry 102 includes means for audio data interfacing. For example, the means for data interfacing may be implemented by audio data interface circuitry 202. In some examples, the audio data interface circuitry 202 may be instantiated by processor circuitry such as the example processor circuitry 1012 of FIG. 10. For instance, the audio data interface circuitry 202 may be instantiated by the example microprocessor 1200 of FIG. 12 executing machine executable instructions such as those implemented by at least block 802 of FIG. 8. In some examples, the audio data interface circuitry 202 may be instantiated by hardware logic circuitry, which may be implemented by an ASIC, XPU, or the FPGA circuitry 1300 of FIG. 13 structured to perform operations corresponding to the machine readable instructions. Additionally or alternatively, the audio data interface circuitry 202 may be instantiated by any other combination of hardware, software, and/or firmware. For example, the audio data interface circuitry 202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the model generator circuitry 102 includes means for audio segmenting. For example, the means for audio segmenting may be implemented by the audio segmenter circuitry 204. In some examples, the audio segmenter circuitry 204 may be instantiated by processor circuitry such as the example processor circuitry 1012 of FIG. 10. For instance, the audio segmenter circuitry 204 may be instantiated by the example microprocessor 1200 of FIG. 12 executing machine executable instructions such as those implemented by at least block 804 of FIG. 8. In some examples, the audio segmenter circuitry 204 may be instantiated by hardware logic circuitry, which may be implemented by an ASIC, XPU, or the FPGA circuitry 1300 of FIG. 13 structured to perform operations corresponding to the machine readable instructions. Additionally or alternatively, the audio segmenter circuitry 204 may be instantiated by any other combination of hardware, software, and/or firmware. For example, the audio segmenter circuitry 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the model generator circuitry 102 includes means for segment labeling. For example, the means for segment labeling may be implemented by the segment labeler circuitry 206. In some examples, the segment labeler circuitry 206 may be instantiated by processor circuitry such as the example processor circuitry 1012 of FIG. 10. For instance, the segment labeler circuitry 206 may be instantiated by the example microprocessor 1200 of FIG. 12 executing machine executable instructions such as those implemented by at least block 806 of FIG. 8. In some examples, the segment labeler circuitry 206 may be instantiated by hardware logic circuitry, which may be implemented by an ASIC, XPU, or the FPGA circuitry 1300 of FIG. 13 structured to perform operations corresponding to the machine readable instructions. Additionally or alternatively, the segment labeler circuitry 206 may be instantiated by any other combination of hardware, software, and/or firmware. For example, the segment labeler circuitry 206 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the model generator circuitry 102 includes means for audio preprocessing. For example, the means for audio preprocessing may be implemented by the audio preprocessor circuitry 208. In some examples, the audio preprocessor circuitry 208 may be instantiated by processor circuitry such as the example processor circuitry 1012 of FIG. 10. For instance, the audio preprocessor circuitry 208 may be instantiated by the example microprocessor 1200 of FIG. 12 executing machine executable instructions such as those implemented by at least block 808 of FIG. 8. In some examples, the audio preprocessor circuitry 208 may be instantiated by hardware logic circuitry, which may be implemented by an ASIC, XPU, or the FPGA circuitry 1300 of FIG. 13 structured to perform operations corresponding to the machine readable instructions. Additionally or alternatively, the audio preprocessor circuitry 208 may be instantiated by any other combination of hardware, software, and/or firmware. For example, the audio preprocessor circuitry 208 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the model generator circuitry 102 includes means for model training. For example, the means for model training may be implemented by the model trainer circuitry 210. In some examples, the model trainer circuitry 210 may be instantiated by processor circuitry such as the example processor circuitry 1012 of FIG. 10. For instance, the model trainer circuitry 210 may be instantiated by the example microprocessor 1200 of FIG. 12 executing machine executable instructions such as those implemented by at least block 810 of FIG. 8. In some examples, the model trainer circuitry 210 may be instantiated by hardware logic circuitry, which may be implemented by an ASIC, XPU, or the FPGA circuitry 1300 of FIG. 13 structured to perform operations corresponding to the machine readable instructions. Additionally or alternatively, the model trainer circuitry 210 may be instantiated by any other combination of hardware, software, and/or firmware. For example, the model trainer circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the model generator circuitry 102 includes means for model testing. For example, the means for model testing may be implemented by the model tester circuitry 212. In some examples, the model tester circuitry 212 may be instantiated by processor circuitry such as the example processor circuitry 1012 of FIG. 10. For instance, the model tester circuitry 212 may be instantiated by the example microprocessor 1200 of FIG. 12 executing machine executable instructions such as those implemented by at least blocks 812, 814 of FIG. 8. In some examples, the model tester circuitry 212 may be instantiated by hardware logic circuitry, which may be implemented by an ASIC, XPU, or the FPGA circuitry 1300 of FIG. 13 structured to perform operations corresponding to the machine readable instructions. Additionally or alternatively, the model tester circuitry 212 may be instantiated by any other combination of hardware, software, and/or firmware. For example, the model tester circuitry 212 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the model generator circuitry 102 includes means for model deploying. For example, the means for model deploying may be implemented by model deployer circuitry 214. In some examples, the model deployer circuitry 214 may be instantiated by processor circuitry such as the example processor circuitry 1012 of FIG. 10. For instance, the model deployer circuitry 214 may be instantiated by the example microprocessor 1200 of FIG. 12 executing machine executable instructions such as those implemented by at least block 816 of FIG. 8. In some examples, the model deployer circuitry 214 may be instantiated by hardware logic circuitry, which may be implemented by an ASIC, XPU, or the FPGA circuitry 1300 of FIG. 13 structured to perform operations corresponding to the machine readable instructions. Additionally or alternatively, the model deployer circuitry 214 may be instantiated by any other combination of hardware, software, and/or firmware. For example, the model deployer circuitry 214 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing the model generator circuitry 102 of FIG. 1 is illustrated in FIG. 2, one or more of the elements, processes, and/or devices illustrated in FIG. 2 may be combined, divided, re-arranged, omitted, eliminated, and/or implemented in any other way. Further, the example audio data interface circuitry interface 202, example audio segmenter circuitry 204, example segment labeler circuitry 206, example audio preprocessor circuitry 208, example model trainer circuitry 210, example model tester circuitry 212, example model deployer circuitry 214, and/or, more generally, the example model generator circuitry 102 of FIG. 1, may be implemented by hardware alone or by hardware in combination with software and/or firmware. Thus, for example, any of the example audio data interface circuitry interface 202, example audio segmenter circuitry 204, example segment labeler circuitry 206, example audio preprocessor circuitry 208, example model trainer circuitry 210, example model tester circuitry 212, example model deployer circuitry 214, and/or, more generally, the example model generator circuitry 102, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example A1 of FIG. 1 may include one or more elements, processes, and/or devices in addition to, or instead of, those illustrated in FIG. 2, and/or may include more than one of any or all of the illustrated elements, processes and devices.

FIG. 3 is a block diagram of an example implementation of the audio processor circuitry 104 of FIG. 1 to identify the vocal effort in audio data. In the illustrated example of FIG. 3, the audio processor circuitry 104 includes example audio data interface circuitry 302, example audio preprocessor circuitry 304, example audio segmenter circuitry 306, example neural network interface circuitry 308, example metadata generator circuitry 310, example metadata aggregator circuitry 312, and example metadata applicator interface circuitry 314. The audio processor circuitry 104 of FIG. 3 may be instantiated (e.g., creating an instance of, bring into being for any length of time, materialize, implement, etc.) by processor circuitry such as a central processing unit executing instructions. Additionally or alternatively, the audio processor circuitry 104 of FIG. 3 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 3 may, thus, be instantiated at the same or different times. Some or all of the circuitry may be instantiated, for example, in one or more threads executing concurrently on hardware and/or in series on hardware. Moreover, in some examples, some or all of the circuitry of FIG. 3 may be implemented by microprocessor circuitry executing instructions to implement one or more virtual machines and/or containers.

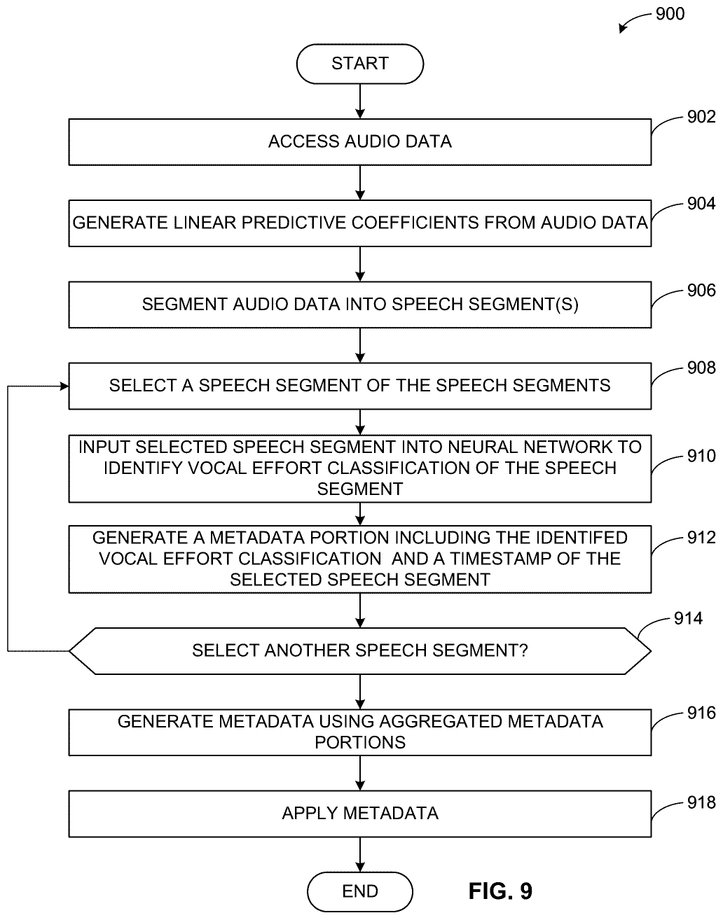

The example audio data interface circuitry 302 accesses audio data (e.g., the vocal data 101, etc.) from an audio database, microphone, and/or another audio source. accesses audio data. For example, the audio data interface circuitry 302 can access live-captured audio data (e.g., captured via one or more microphones associated with the audio processor circuitry 104, etc.). In some examples, the audio data interface circuitry 302 can access recorded media (e.g., from a local database, from an online database, etc.). In some such examples, the accessed media can be associated with recorded entertainment media (e.g., television programs, movies, etc.), informative media (e.g., speeches, lectures, etc.), commercial media (e.g., advertisements, etc.), and/or other media (e.g., recorded business meetings, etc.). In some examples, the audio data interface circuitry 302 is instantiated by processor circuitry executing audio data interface instructions and/or configured to perform operations such as those represented by the flowchart of FIG. 9.

The example audio preprocessor circuitry 304 preprocesses the audio into a format suitable for input into the neural network associated with the audio processor circuitry 104. For example, the audio preprocessor circuitry 304 can generate linear predictive coefficients from the audio data. For example, the audio preprocessor circuitry 304 can use LPC processing techniques to generate LPC coefficients. In some examples, the audio preprocessor circuitry 304 can generate LPC coefficient vectors including 24 frequency bins (e.g., 24 elements, etc.). In other examples, the audio preprocessor circuitry 304 can generate LPC coefficients of any suitable size (e.g., 128 elements, 12 elements, 48 elements, etc.). In some such examples, the audio preprocessor circuitry 304 can inverse filter the audio data to estimate the frequency and intensity of the audio date. In some such examples, the residue of the audio data is filtered and used to synthesize the LPC coefficients. Additionally or alternatively, the audio preprocessor circuitry 304 can preprocess the audio data via any other audio processing techniques, including fast Fourier transforms (FFT) and/or Walsh-Hadamard transforms. In some examples, the audio preprocessor circuitry 304 is instantiated by processor circuitry executing audio preprocessor instructions and/or configured to perform operations such as those represented by the flowchart of FIG. 9.

The example audio segmenter circuitry 306 segments the received audio data into discrete segments. For example, the audio segmenter circuitry 306 can generate a plurality of audio segments of equal duration (e.g., 100-millisecond segments, 500-millisecond segments, one-second segments, three-second segments, etc.). In other examples, the audio segmenter circuitry 306 can generate a plurality of audio segments of non-equal durations. In other examples, the audio segmenter circuitry 306 can divide the accessed audio data into any other suitable segments. In some examples, the audio segmenter circuitry 306 is instantiated by processor circuitry executing audio segmenter instructions and/or configured to perform operations such as those represented by the flowchart of FIG. 9.

The example neural network interface circuitry 308 interfaces with a neural network associated with the audio processor circuitry 104. For example, the neural network interface circuitry 308 can input the selected audio segment into the neural network to the identified vocal effort classification of the audio segment. For example, the neural network interface circuitry 308 can input the selected data into the neural network generated by the model generator circuitry 102. The neural network interfaced with the neural network interface circuitry 308 can be generated by the model generator circuitry 102. In some examples, the neural network can be implemented by any suitable type of neural network and/or machine learning model. In some examples, the neural network interface circuitry 308 is instantiated by processor circuitry executing neural network interface instructions and/or configured to perform operations such as those represented by the flowchart of FIG. 9.

The example metadata generator circuitry 310 generates metadata portions including the identified vocal effort classification and a timestamp of the selected audio segment. For example, the metadata generator circuitry 310 can generate a metadata portion including an integer value corresponding to the vocal effort classification of the audio segment output by the neural network (e.g., an integer value of “1” corresponding to the first vocal effort classification 114A, an integer value of “2” corresponding to the second vocal effort classification 114B, an integer value of “3” corresponding to the third vocal effort classification 114C, an integer value of “4” corresponding to the fourth vocal effort classification 114D, an integer value of “5” corresponding to the fifth vocal effort classification 114E, etc.). In some examples, the metadata generator circuitry 310 outputs a value corresponding to the timestamp of the audio segment. In some such examples, the timestamp is an absolute time, a relative time of the audio segment within the audio data, and/or an integer value corresponding to the chronological location of the audio segment (e.g., a first audio segment chronologically has a timestamp of “1,” a seventh audio segment chronologically has a timestamp of “7,” etc.). In some examples, the neural metadata generator circuitry 310 is instantiated by processor circuitry executing metadata generator instructions and/or configured to perform operations such as those represented by the flowchart of FIG. 9.

The example metadata aggregator circuitry 312 generates the metadata 108 using aggregated metadata portions. For example, the metadata aggregator circuitry 312 can combine the metadata portions generated by the metadata generator circuitry 310 into the metadata 108. In some examples, the metadata aggregator circuitry 312 can generate the metadata 108 as a matrix. In other examples, the metadata aggregator circuitry 312 can have any other suitable data structure. In some examples, the metadata aggregator circuitry 312 is instantiated by processor circuitry executing metadata aggregator instructions and/or configured to perform operations such as those represented by the flowchart of FIG. 9.

The example metadata applicator interface circuitry 314 interfaces with the metadata applicator circuitry 112. For example, the metadata applicator interface circuitry 314 can cause the metadata applicator circuitry 112 to receive and apply the metadata 108. For example, the metadata applicator interface circuitry 314 can cause the metadata applicator circuitry 112 to annotate speech-to-text output associated with the received audio data with the detected vocal effort. In some examples, the metadata applicator interface circuitry 314 can cause the metadata applicator circuitry 112 to annotate a speech-to-text output associated with the vocal data 101 with appropriate punctuation. Additionally or alternatively, the metadata applicator interface circuitry 314 can cause the metadata applicator circuitry 112 to detect emotion and/or speaker investment, enhance the sound quality of the vocal data 101 using the metadata 108 (e.g., signal enhancement, noise reduction, etc.), and/or augment the vocal data 101 using the metadata 108 and enhancement/transformation algorithms depending on the detected vocal effects. In other examples, the metadata applicator interface circuitry 314 can cause the metadata applicator circuitry 112 to apply the metadata in any other suitable manner. In some examples, the metadata applicator interface circuitry 314 is instantiated by processor circuitry executing metadata applicator interface instructions and/or configured to perform operations such as those represented by the flowchart of FIG. 9.

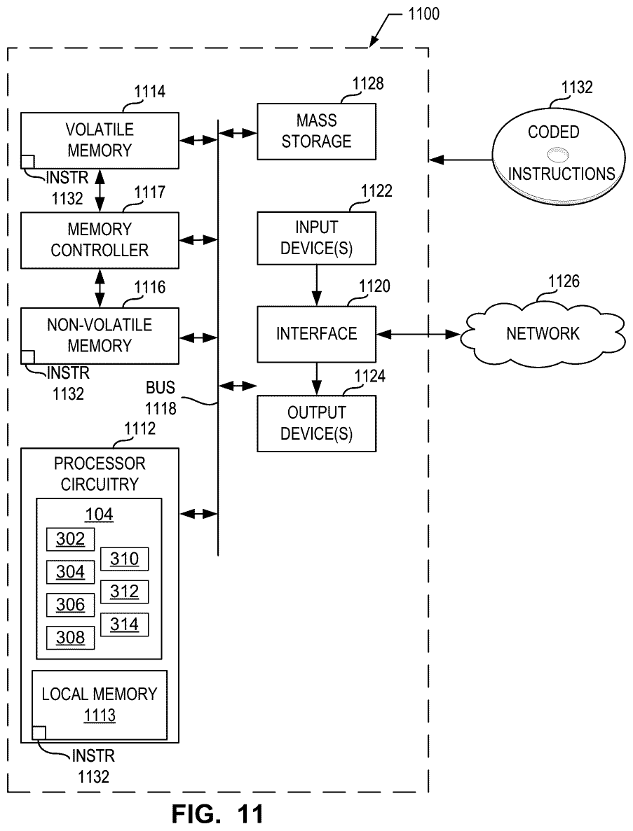

In some examples, the audio processor circuitry 104 includes means for audio data interfacing. For example, the means for audio data interfacing may be implemented by the audio data interface circuitry 302. In some examples, the audio data interface circuitry 302 may be instantiated by processor circuitry such as the example processor circuitry 1112 of FIG. 11. For instance, the audio data interface circuitry 302 may be instantiated by the example microprocessor 1200 of FIG. 12 executing machine executable instructions such as those implemented by at least block 902 of FIG. 9. In some examples, the audio data interface circuitry 302 may be instantiated by hardware logic circuitry, which may be implemented by an ASIC, XPU, or the FPGA circuitry 1300 of FIG. 13 structured to perform operations corresponding to the machine readable instructions. Additionally or alternatively, the audio data interface circuitry 302 may be instantiated by any other combination of hardware, software, and/or firmware. For example, the audio data interface circuitry 302 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the audio processor circuitry 104 includes means for audio preprocessing. For example, the means for audio preprocessing may be implemented by the audio preprocessor circuitry 304. In some examples, the audio preprocessor circuitry 304 may be instantiated by processor circuitry such as the example processor circuitry 1112 of FIG. 11. For instance, the audio preprocessor circuitry 304 may be instantiated by the example microprocessor 1200 of FIG. 12 executing machine executable instructions such as those implemented by at least block 904 of FIG. 9. In some examples, the audio preprocessor circuitry 304 may be instantiated by hardware logic circuitry, which may be implemented by an ASIC, XPU, or the FPGA circuitry 1300 of FIG. 13 structured to perform operations corresponding to the machine readable instructions. Additionally or alternatively, the audio preprocessor circuitry 304 may be instantiated by any other combination of hardware, software, and/or firmware. For example, the audio preprocessor circuitry 304 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the audio processor circuitry 104 includes means for audio segmenting. For example, the means for audio segmenting may be implemented by the audio segmenting circuitry 306. In some examples, the audio segmenting circuitry 306 may be instantiated by processor circuitry such as the example processor circuitry 1112 of FIG. 11. For instance, the audio segmenting circuitry 306 may be instantiated by the example microprocessor 1200 of FIG. 12 executing machine executable instructions such as those implemented by at least blocks 906, 908, 914 of FIG. 9. In some examples, the audio segmenting circuitry 306 may be instantiated by hardware logic circuitry, which may be implemented by an ASIC, XPU, or the FPGA circuitry 1300 of FIG. 13 structured to perform operations corresponding to the machine readable instructions. Additionally or alternatively, the audio segmenting circuitry 306 may be instantiated by any other combination of hardware, software, and/or firmware. For example, the audio segmenting circuitry 306 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the audio processor circuitry 104 includes means for interfacing with a neural network. For example, the means for interfacing with a neural network may be implemented by the neural network interfacing circuitry 308. In some examples, the neural network interfacing circuitry 308 may be instantiated by processor circuitry such as the example processor circuitry 1112 of FIG. 11. For instance, the neural network interfacing circuitry 308 may be instantiated by the example microprocessor 1200 of FIG. 12 executing machine executable instructions such as those implemented by at least blocks 910 of FIG. 9. In some examples, the neural network interfacing circuitry 308 may be instantiated by hardware logic circuitry, which may be implemented by an ASIC, XPU, or the FPGA circuitry 1300 of FIG. 13 structured to perform operations corresponding to the machine readable instructions. Additionally or alternatively, the neural network interfacing circuitry 308 may be instantiated by any other combination of hardware, software, and/or firmware. For example, the neural network interfacing circuitry 308 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the audio processor circuitry 104 includes means for generating metadata. For example, the means for generating metadata may be implemented by the metadata generator circuitry 310. In some examples, the metadata generator circuitry 310 may be instantiated by processor circuitry such as the example processor circuitry 1112 of FIG. 11. For instance, the metadata generator circuitry 310 may be instantiated by the example microprocessor 1200 of FIG. 12 executing machine executable instructions such as those implemented by at least block 912 of FIG. 9. In some examples, the metadata generator circuitry 310 may be instantiated by hardware logic circuitry, which may be implemented by an ASIC, XPU, or the FPGA circuitry 1300 of FIG. 13 structured to perform operations corresponding to the machine readable instructions. Additionally or alternatively, the metadata generator circuitry 310 may be instantiated by any other combination of hardware, software, and/or firmware. For example, the metadata generator circuitry 310 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the audio processor circuitry 104 includes means for metadata aggregating. For example, the means for aggregating may be implemented by the metadata aggregator circuitry 312. In some examples, the metadata aggregator circuitry 312 may be instantiated by processor circuitry such as the example processor circuitry 1112 of FIG. 11. For instance, the metadata aggregator circuitry 312 may be instantiated by the example microprocessor 1200 of FIG. 12 executing machine executable instructions such as those implemented by at least blocks 916 of FIG. 9. In some examples, the metadata aggregator circuitry 312 may be instantiated by hardware logic circuitry, which may be implemented by an ASIC, XPU, or the FPGA circuitry 1300 of FIG. 13 structured to perform operations corresponding to the machine readable instructions. Additionally or alternatively, the metadata aggregator circuitry 312 may be instantiated by any other combination of hardware, software, and/or firmware. For example, the metadata aggregator circuitry 312 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the audio processor circuitry 104 includes means for metadata applicator interfacing. For example, the means for metadata applicator interfacing may be implemented by the metadata applicator interface circuitry 314. In some examples, the metadata applicator interface circuitry 314 may be instantiated by processor circuitry such as the example processor circuitry 1112 of FIG. 11. For instance, the metadata applicator interface circuitry 314 may be instantiated by the example microprocessor 1200 of FIG. 12 executing machine executable instructions such as those implemented by at least blocks of FIG. 9. In some examples, the metadata applicator interface circuitry 314 may be instantiated by hardware logic circuitry, which may be implemented by an ASIC, XPU, or the FPGA circuitry 1300 of FIG. 13 structured to perform operations corresponding to the machine readable instructions. Additionally or alternatively, the metadata applicator interface circuitry 314 may be instantiated by any other combination of hardware, software, and/or firmware. For example, the metadata applicator interface circuitry 314 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing the audio processor circuitry 104 FIG. 1 is illustrated in FIG. 3, one or more of the elements, processes, and/or devices illustrated in FIG. 3 may be combined, divided, re-arranged, omitted, eliminated, and/or implemented in any other way. Further, the example audio data interface circuitry 302, example audio preprocessor circuitry 304, example audio segmenter circuitry 306, example neural network interface circuitry 308, example metadata generator circuitry 310, example metadata aggregator circuitry 312, and example metadata applicator interface circuitry 314, and/or, more generally, the example audio processor circuitry 104 of FIG. 1, may be implemented by hardware alone or by hardware in combination with software and/or firmware. Thus, for example, any of the example audio data interface circuitry 302, example audio preprocessor circuitry 304, example audio segmenter circuitry 306, example neural network interface circuitry 308, example metadata generator circuitry 310, example metadata aggregator circuitry 312, and example metadata applicator interface circuitry 314, and/or, more generally, the example audio processor circuitry 104, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example audio processor circuitry 104 of FIG. 1 may include one or more elements, processes, and/or devices in addition to, or instead of, those illustrated in FIG. 3, and/or may include more than one of any or all of the illustrated elements, processes and devices.

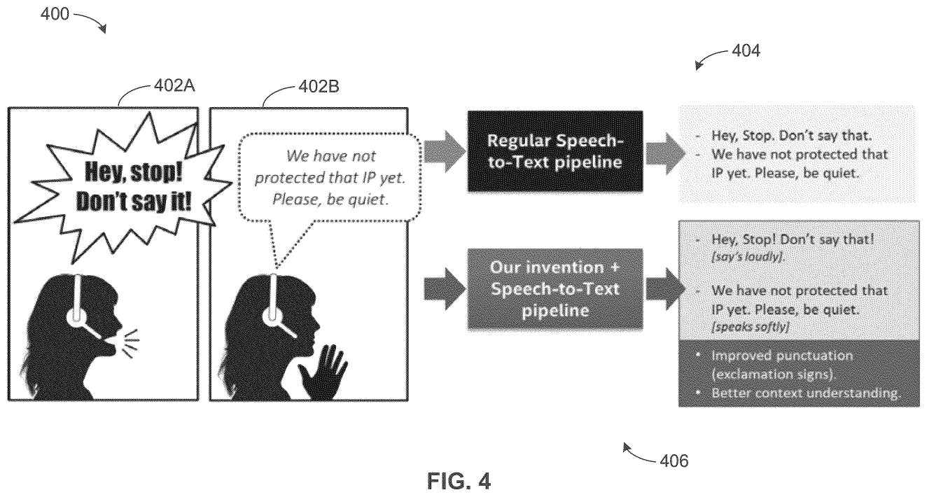

FIG. 4 is a schematic illustration of an example process 400 of the metadata applicator circuitry 112 of the vocal effort detection system 100. The process 400 includes an example first vocal input 402A and an example second vocal input 402B. The first vocal input 402A has the first vocal effort classification 114A (e.g., yelled) and the second vocal input 402B has the fourth vocal effort classification 114D (e.g., soft). In the illustrated example of FIG. 4, a prior speech-to-text system generates a first output 404, which transcribes the words associated with the vocal inputs in plain text, without an indication of tone or speaker intent. In the illustrated example of FIG. 4, the vocal effort detection system 100, in conjunction with a prior speech-to-text system, generates an example second output 406, which includes the transcribed text with metadata (e.g., the metadata 108, etc.). In the illustrated example of FIG. 4, the metadata applicator circuitry 112 uses the metadata 108 to add exclamation marks with the speech with the first vocal input 402A (e.g., because the vocal effort is yelled, etc.) and to add the “speak softly” to the speech associated with the second vocal input 402B (e.g., because the vocal effort is soft, etc.). Accordingly, the vocal effort detection system 100 improves the punctuation of the transcription of the vocal inputs 402A, 402B and by adding context that conveys a clearer understanding of the intent of the speaker conveyed in the conversation than the first output 404.

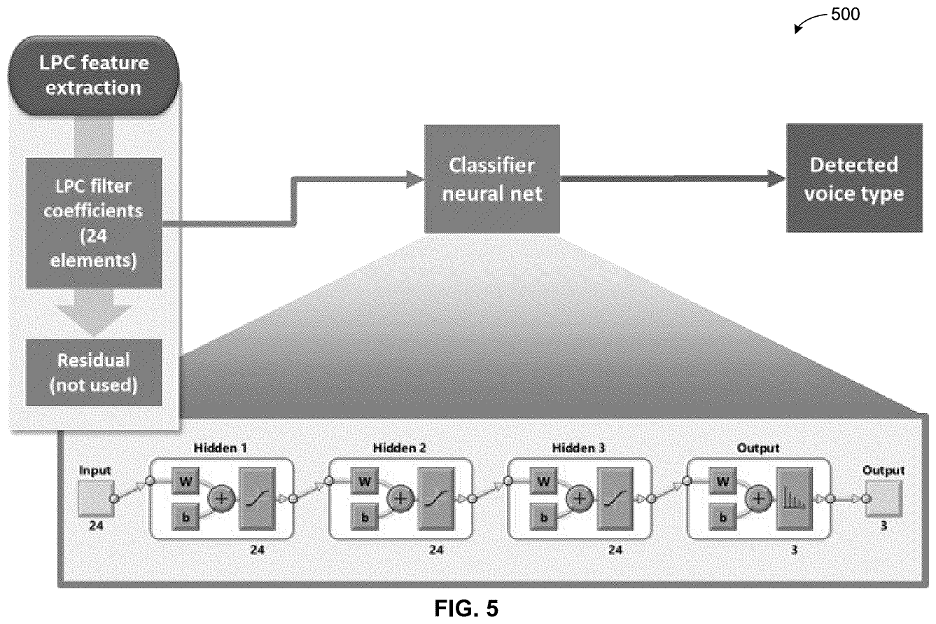

FIG. 5 is a schematic illustration of another example implementation 500 of the audio processor circuitry 104 of FIG. 1. In the illustration example of FIG. 5, the implementation 500 includes a feed-forward, fully connected neural network, that includes a three-layer classifier. The neural network receives a 24-element LPC coefficient vector as an input, which is generated by preprocessing input audio data. The neural network outputs an integer corresponding to the detected vocal effort within the vocal effort.

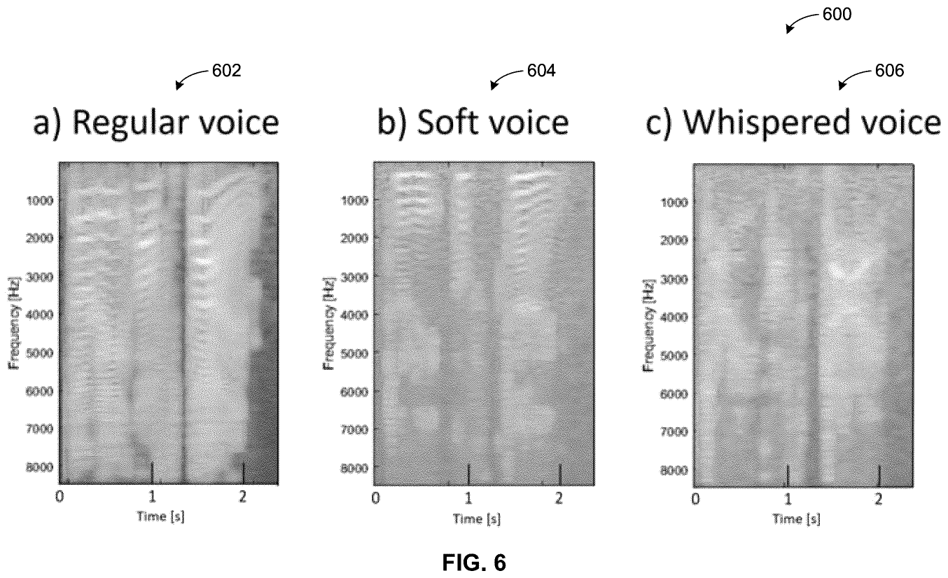

FIG. 6 is an example illustration 600 that includes an example first spectrogram 602, an example second spectrogram 604, and an example third spectrogram 606. In the illustrated example of FIG. 6, the example spectrograms 602, 604, 606 are time-frequency representations of audio data (e.g., the vocal data 101, etc.). In the illustrated example of FIG. 6, the example spectrograms 602, 604, 606 are associated with the same phrase being spoken by the same speaker with different vocal efforts. The example spectrograms 602, 604, 606 are example representations of LPC coefficients associated with speech associated with regular vocal effort (e.g., the third vocal effort classification 114C, etc.), soft vocal effort (e.g., the fourth vocal effort classification 114D, etc.), and whisper vocal effort (e.g., the fifth vocal effort classification 114E, etc.), respectively. In other examples, the spectrograms 602, 604, 606 can be generated by any other suitable process (e.g., a Fast Fourier transform, etc.).

The first spectrogram 602 has normal vocal amplitude (e.g., loudness, etc.), pitch, and harmonics. The second spectrogram 604 has a lower amplitude, a lower pitch, and close harmonics to the first spectrogram 602. The third spectrogram 606 has no harmonics and lower amplitude than the first spectrogram 602. Accordingly, a principle difference between the fourth vocal effort classification 114D (e.g., soft vocal effort, etc.) and the fifth vocal effort classification 114E (e.g., whispered vocal effort, etc.) is the presence of harmonics in the fourth vocal effort classification and the absence of harmonics in the fifth vocal effort classification.

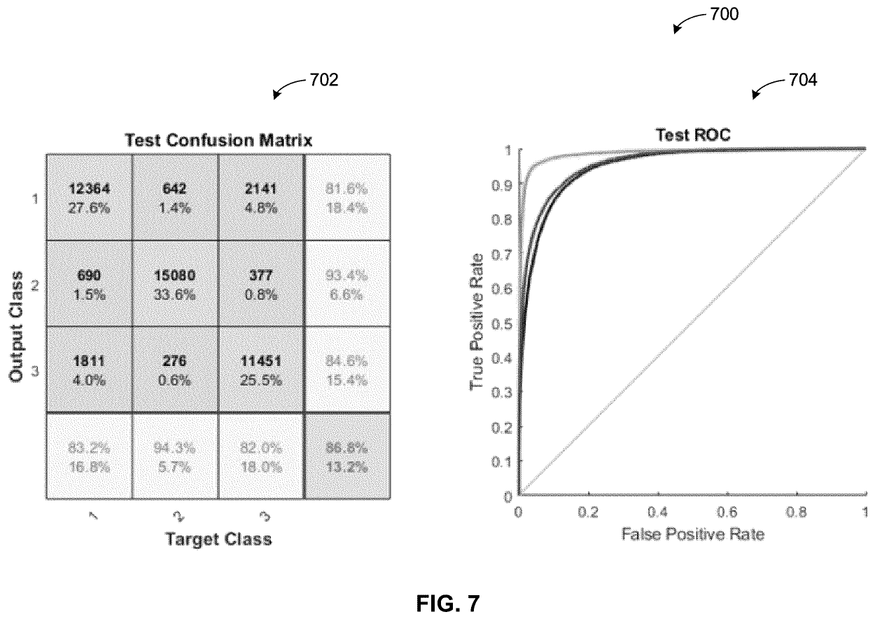

FIG. 7 depicts a summary 700 of potential results of an example audio processor circuitry of FIGS. 1 and 3. The summary 700 includes an example confusion matrix 702 and an example results graph 704. The confusion matrix and the results graph 704 can be generated by the model tester circuitry 212 of FIG. 2 of the model generator circuitry 102 of FIG. 1.

The confusion matrix 702 includes output class rows and target class columns, each having respective values of “1,” “2,” and “3.” In some examples, the values “1,” “2,” and “3” can correspond to the first vocal effort classification 114A (e.g., the regular vocal classification, etc.), a second vocal effort classification 114B, (e.g., a soft vocal classification, etc.), and a third vocal effort classification 114C (e.g., a whisper vocal classification, etc.). In other examples, the values can correspond to any other suitable vocal classification. Each respective row and column corresponds to a vocal effort classification. The output rows correspond to an output of a neural network implemented in accordance with the teachings of this disclosure (e.g., output by the model trainer circuitry 210 of FIG. 2 of the model generator circuitry 102 of FIG. 1, etc.) and the target columns correspond to the actual vocal effort (e.g., the output of the segment labeler circuitry 206, etc.) of the received audio segments. The intersection of the rows and the target columns represent a potential combination of results of the neural network. For example, the block of the confusion matrix 702 of output row “2” and target column “1” represents the percentage of “2” outputs of the neural network for an audio sample with the input “1” (e.g., a false identification, etc.) the block of the matrix 702 of output row “1” and target column “1” represents the percentage of “1” outputs of the neural network for an audio sample with a “1” input (e.g., a true identification, etc.), etc. The lower left block represents the total percent of accurate identifications of the neural network. The model tester circuitry 212 can compare this value to a threshold value to determine if the neural network can be deployed.

The results graph 704 is a receiver operator classification (ROC) curve that tracks the performance of the neural network as a function of false positives and true positives at different classification thresholds. Each line on the results graph represents a different vocal effort input.

Flowcharts representative of example machine readable instructions, which may be executed to configure processor circuitry to implement the model generator circuitry 102 of FIG. 2 and the audio processor circuitry 104 are shown in FIGS. 8 and 9, respectively. The machine readable instructions may be one or more executable programs or portion(s) of an executable program for execution by processor circuitry, such as the processor circuitry 1012 shown in the example processor platform 1000 discussed below in connection with FIG. 10, the processor circuitry 1112 shown in the example processor platform 1100 discussed below in connection with FIG. 11, and/or the example processor circuitry discussed below in connection with FIGS. 12 and/or 13. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program(s) is/are described with reference to the flowcharts illustrated in FIGS. 8 and 9, many other methods of implementing the example model generator circuitry 102 and/or the audio processor circuitry 104 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 8 and 9 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 8 is a flowchart representative of example machine readable instructions and/or example operations 800 that may be executed and/or instantiated by processor circuitry to generate a neural network mode to identify the vocal effort(s) of audio. The machine readable instructions and/or the operations 800 of FIG. 8 begin at block 802, at which the audio data interface circuitry 202 access audio data. For example, the audio data interface circuitry 202 accesses audio data from a microphone, an audio database, and/or another source of audio. For example, the audio data interface circuitry 202 can access live-captured audio data (e.g., captured via one or more microphones associated with the model generator circuitry 102, etc.). In some examples, the audio data interface circuitry 202 can access recorded media (e.g., from a local database, from an online database, etc.). In some such examples, the accessed media can be associated with recorded entertainment media (e.g., television programs, movies, etc.), informative media (e.g., speeches, lectures, etc.), commercial media (e.g., advertisements, etc.), and/or other media (e.g., recorded business meetings, etc.). In some examples, the accessed audio data can be generated specifically to train a vocal effort neural network.

At block 804, the audio segmenter circuitry 204 segments the audio data into first audio segments and second audio segments. For example, the audio segmenter circuitry 204 can segment the accessed audio data into a plurality of discrete audio segments. In some examples, the audio segmenter circuitry 204 can generate a plurality of audio segments of equal duration (e.g., 100-millisecond segments, 500-millisecond segments, one-second segments, three-second segments, etc.). In other examples, the audio segmenter circuitry 204 can generate a plurality of audio segments of non-equal durations. In other examples, the audio segmenter circuitry 204 can divide the accessed audio data into any other segments. The audio segmenter circuitry 204 can divide the audio data segments into first audio data segments, corresponding to audio segments to be used to train a neural network (e.g., training data, training segments, etc.), and second audio data segments, corresponding to be used to test the trained neural network (e., testing data, testing segments, etc.).

At block 806, the segment labeler circuitry 206 labels the first and second audio data segments by identifying voice-effort classifications. For example, the segment labeler circuitry 206 can present the audio data segments to a technician (e.g., a user, etc.) and prompt the user to identify the vocal effort classification(s) of the presented audio data segments. In other examples, the segment labeler circuitry 206 can label the first and second audio data segments via audio analysis (e.g., analysis of the tone, pitch, harmonics, etc.). In some such examples, the segment labeler circuitry 206 can label each one of the first and second audio data segments with a corresponding vocal effort classification (e.g., one or the vocal effort classifications 114A, 114B, 114C, 114D, 114E of FIG. 1, etc.).

At block 808, the audio preprocessor circuitry 208 generates linear prediction coding (LPC) coefficients from the first audio segments and second audio segments. For example, the audio preprocessor circuitry 208 can use LPC processing techniques to generate LPC coefficients. In some examples, the audio preprocessor circuitry 208 can generate LPC coefficient vectors including 24 frequency bins (e.g., 24 elements, etc.). In other examples, the audio preprocessor circuitry 208 can generate LPC coefficients of any suitable size (e.g., 128 elements, 12 elements, 48 elements, etc.). In some such examples, the audio preprocessor circuitry 208 can inverse filter the audio data to estimate the frequency and intensity of the audio data. In some such examples, the residue of the audio data can be filtered and used to synthesize the LPC coefficients. Additionally or alternatively, the audio preprocessor circuitry 208 can preprocess the audio data via any other audio processing techniques, including fast Fourier transforms (FFT) and/or Walsh-Hadamard transforms.

At block 810, the model trainer circuitry 210 trains a neural network with labeled first audio segments. For example, the model trainer circuitry 210 can train a neural network using the labeled first audio segments via supervised learning. In some such examples, the model trainer circuitry 210 can use any suitable supervised learning method (e.g., support vector machine, linear regressions, logistic regression, discriminant function analysis, decision tree learning, etc.). In some examples, the model trainer circuitry 210 can train a neural network that is three-layered, feedforward, and fully connected. In other examples, the neural network trained by the model trainer circuitry 210 can be another type of neural network (e.g., a recurrent neural network (RNN), a long short-term memory (LSTM) neural network, etc.). In other examples, the model trainer circuitry 210 can train the neural network in any other suitable training technique, including unsupervised learning.

At block 812, the model tester circuitry 212 tests the neural network using second labeled audio segments. For example, the model tester circuitry 212 can input the second audio segments into the trained neural network, generated by the model trainer circuitry 210, record the output of the neural network, and compare the trained neural network to labels of the second audio segments. In some such examples, the model tester circuitry 212 can generate accuracy statistics (e.g., a percentage of outputs of the neural network that match the corresponding label generated by the segment labeler circuitry 206, etc.). In other examples, the model tester circuitry 212 can test the generated neural network in any other suitable manner. At block 814, the model tester circuitry 212 determines if the neural network satisfies the accuracy threshold. For example, the model tester circuitry 212 can compare the accuracy statistics generated by the model tester circuitry 212 to a preset accuracy threshold. In some such examples, the accuracy threshold can be any suitable value (e.g., 75%, 90%, 99%, etc.). In other examples, the model tester circuitry 212 can determine if the generated neural network is sufficiently accurate in any other suitable manner. If the model tester circuitry 212 determines the neural network satisfies the accuracy threshold, the operations 800 advance to block 816. If the model tester circuitry 212 determines the neural network does not satisfy the accuracy threshold, the operations 800 return to block 802.

At block 816, the model deployer circuitry 214 deploys neural network. For example, the model deployer circuitry 214 can transmit the neural network to the audio processor circuitry 104. Additionally or alternatively, the model deployer circuitry 214 can publish the neural network to the cloud platform, an edge platform, and/or another suitable platform. In other examples, the model deployer circuitry 214 can deploy the neural network in any other suitable manner. The operations 800 end.

FIG. 9 is a flowchart representative of example machine readable instructions and/or example operations 900 that may be executed and/or instantiated by processor circuitry to identify the vocal effort(s) associated with audio. The machine readable instructions and/or the operations 900 of FIG. 9 begin at block 902, at which the audio data interface circuitry 302 accesses audio data. For example, the audio data interface circuitry 302 accesses audio data. For example, the audio data interface circuitry 302 can access live-captured audio data (e.g., captured via one or more microphones associated with the audio processor circuitry 104, etc.). In some examples, the audio data interface circuitry 302 can access recorded media (e.g., from local database, from an online database, etc.). In some such examples, the accessed media can be associated with recorded entertainment media (e.g., television programs, movies, etc.), informative media (e.g., speeches, lectures, etc.), commercial media (e.g., advertisements, etc.), and/or other media (e.g., recorded business meetings, etc.).

At block 904, the audio preprocessor circuitry 304 generates linear predictive coefficients from the audio data. For example, the audio preprocessor circuitry 304 can use LPC processing techniques to generate LPC coefficients. In some examples, the audio preprocessor circuitry 304 can generate LPC coefficients vectors including 24 frequency bins (e.g., 24 elements, etc.). In other examples, the audio preprocessor circuitry 304 can generate LPC coefficients of any suitable size (e.g., 128 elements, 12 elements, 48 elements, etc.). In some such examples, the audio preprocessor circuitry 304 can inverse filter the audio data to estimate the frequency and intensity of the audio date. In some such example, the residue of the audio data can filtered and used to synthesize the LPC coefficients. Additionally or alternatively, the audio preprocessor circuitry 304 can preprocess the audio data via any other audio processing techniques, including fast Fourier transforms (FFT) and/or Walsh-Hadamard transform.

At block 906, the audio segmenter circuitry 306 segments audio data into audio segments. For example, the audio segmenter circuitry 306 can segment the accessed audio data into a plurality of discrete audio segments. In some examples, the audio segmenter circuitry 306 can generate a plurality of audio segments of equal duration (e.g., 100-millisecond segments, 500-millisecond segments, one-second segments, three-second segments, etc.). In other examples, the audio segmenter circuitry 306 can generate a plurality of audio segments of non-equal durations. In other examples, the audio segmenter circuitry 306 can divide the accessed audio data into any other suitable segments.

At block 908, the audio segmenter circuitry 306 selects an audio segment of the audio segments. For example, the audio segmenter circuitry 306 can select a first one of the audio segments and/or the next chronological one of the audio segments. In other examples, the audio segmenter circuitry 306 can select any previously unselected audio segment of the audio segments. At block 910, the neural network interface circuitry 308 inputs the selected audio segment into the neural network to the identified vocal effort classification of the audio segment. For example, the neural network interface circuitry 308 can input the selected data into the neural network generated by the model generator circuitry 102. The neural network interfaced with the neural network interface circuitry 308 can be generated by the model generator circuitry 102. In some examples, the neural network can be implemented by any suitable type of neural network and/or machine learning model.

At block 912, the metadata generator circuitry 310 generates a metadata portion including the identified vocal effort classification and a timestamp of the selected audio segment. For example, the metadata generator circuitry 310 can generate a metadata portion including an integer value corresponding to the vocal effort classification of the audio segment output by the neural network during the execution of block 910. In some examples, the metadata generator circuitry 310 outputs a value corresponding to the timestamp of the audio segment. In some such examples, the timestamp is an absolute time, a relative time of the audio segment within the audio data, and/or an integer value corresponding to the chronological location of the audio segment (e.g., a first audio segment chronologically has a timestamp of “1,” a seventh audio segment chronologically has a timestamp of “7,” etc.). In other examples, the metadata generator circuitry 310 can generate metadata portions in any other suitable format.

At block 914, the audio segmenter circuitry 306 determines if another audio segment is to be selected. For example, the audio segmenter circuitry 306 can determine if another segment is to be selected if there are audio segments that have yet to be analyzed. Additionally or alternatively, the audio segmenter circuitry 306 can determine if another segment is to be selected based on a user input. If the audio segmenter circuitry 306 determines another audio segment is to be selected, the operations 900 returns to block 908. If the audio segmenter circuitry 306 determines another audio segment is not to be selected, the operations 900 advances to block 916.

At block 916, the metadata aggregator circuitry 312 generates the metadata 108 using aggregated metadata portions. For example, the metadata aggregator circuitry 312 can combine the metadata portions generated by the metadata generator circuitry 310 into the metadata 108. In some examples, the metadata aggregator circuitry 312 can generate the metadata 108 into a matrix. In other examples, the metadata aggregator circuitry 312 can generate the metadata 108 in any other suitable format.

At block 918, the metadata applicator interface circuitry 314 applies the metadata 108. For example, the metadata applicator interface circuitry 314 can cause the metadata applicator circuitry 112 to receive and apply the metadata 108. For example, the metadata applicator interface circuitry 314 can cause the metadata applicator circuitry 112 to annotate speech-to-text output associated with the received audio data with the detected vocal effort. In some examples, the metadata applicator interface circuitry 314 can cause the metadata applicator circuitry 112 to annotate a speech-to-text output associated with the vocal data 101 with appropriate punctuation. Additionally or alternatively, the metadata applicator interface circuitry 314 can cause the metadata applicator circuitry 112 to detect emotion and/or speaker investment, enhance the sound quality of the vocal data using the metadata 108 (e.g., signal enhancement, noise reduction, etc.) and/or augment the vocal data using the metadata 108 and enhancement/transformation algorithms depending on the detected vocal effects. In other examples, the metadata applicator interface circuitry 314 can cause the metadata applicator circuitry 112 to apply the metadata in any other suitable manner. The operations 900 end.

FIG. 10 is a block diagram of an example processor platform 1100 structured to execute and/or instantiate the machine readable instructions and/or the operations of FIG. 8 to implement the model generator circuitry 102 of FIG. 2. The processor platform 1000 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a Blu-ray player, a gaming console, a headset (e.g., an augmented reality (AR) headset, a virtual reality (VR) headset, etc.) or other wearable device, or any other type of computing device.

The processor platform 1000 of the illustrated example includes processor circuitry 1012. The processor circuitry 1012 of the illustrated example is hardware. For example, the processor circuitry 1012 can be implemented by one or more integrated circuits, logic circuits, FPGAs, microprocessors, CPUs, GPUs, DSPs, and/or microcontrollers from any desired family or manufacturer. The processor circuitry 1012 may be implemented by one or more semiconductor based (e.g., silicon based) devices. In this example, the processor circuitry 1012 implements the audio data interface circuitry 202, the audio segmenter circuitry 204, the segment labeler circuitry 206, the audio preprocessor circuitry 208, the audio preprocessor circuitry 208, the model trainer circuitry 210, the model tester circuitry 212, and the model deployer circuitry 214.

The processor circuitry 1012 of the illustrated example includes a local memory 1013 (e.g., a cache, registers, etc.). The processor circuitry 1012 of the illustrated example is in communication with a main memory including a volatile memory 1014 and a non-volatile memory 1016 by a bus 1018. The volatile memory 1014 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1016 may be implemented by flash memory and/or any other desired type of memory device. Access to the main memory 1014, 1016 of the illustrated example is controlled by a memory controller 1017.

The processor platform 1000 of the illustrated example also includes interface circuitry 1020. The interface circuitry 1020 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1022 are connected to the interface circuitry 1020. The input device(s) 1022 permit(s) a user to enter data and/or commands into the processor circuitry 1012. The input device(s) 1022 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1024 are also connected to the interface circuitry 1020 of the illustrated example. The output device(s) 1024 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1020 of the illustrated example, thus, typically includes a graphics driver card, a graphics driver chip, and/or graphics processor circuitry such as a GPU.

The interface circuitry 1020 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1026. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1000 of the illustrated example also includes one or more mass storage devices 1028 to store software and/or data. Examples of such mass storage devices 1028 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 1032, which may be implemented by the machine readable instructions of FIG. 8, may be stored in the mass storage device 1028, in the volatile memory 1014, in the non-volatile memory 1016, and/or on a removable non-transitory computer readable storage medium such as a CD or DVD.

FIG. 11 is a block diagram of an example processor platform 1100 structured to execute and/or instantiate the machine readable instructions and/or the operations of FIG. 9 to implement the audio processor circuitry 104 of FIG. 3. The processor platform 1100 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a Blu-ray player, a gaming console, a headset (e.g., an augmented reality (AR) headset, a virtual reality (VR) headset, etc.) or other wearable device, or any other type of computing device.

The processor platform 1100 of the illustrated example includes processor circuitry 1112. The processor circuitry 1112 of the illustrated example is hardware. For example, the processor circuitry 1112 can be implemented by one or more integrated circuits, logic circuits, FPGAs, microprocessors, CPUs, GPUs, DSPs, and/or microcontrollers from any desired family or manufacturer. The processor circuitry 1112 may be implemented by one or more semiconductor based (e.g., silicon based) devices. In this example, the processor circuitry 1112 implements the audio data interface circuitry 302, the audio preprocessor circuitry 304, the audio segmenter circuitry 306, the neural network interface circuitry 308, the metadata generator circuitry 310, the metadata aggregator circuitry 312, and the metadata applicator interface circuitry 314.

The processor circuitry 1112 of the illustrated example includes a local memory 1113 (e.g., a cache, registers, etc.). The processor circuitry 1112 of the illustrated example is in communication with a main memory including a volatile memory 1114 and a non-volatile memory 1116 by a bus 1118. The volatile memory 1114 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1116 may be implemented by flash memory and/or any other desired type of memory device. Access to the main memory 1114, 1116 of the illustrated example is controlled by a memory controller 1117.

The processor platform 1100 of the illustrated example also includes interface circuitry 1120. The interface circuitry 1120 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1122 are connected to the interface circuitry 1120. The input device(s) 1122 permit(s) a user to enter data and/or commands into the processor circuitry 1112. The input device(s) 1122 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1124 are also connected to the interface circuitry 1120 of the illustrated example. The output device(s) 1124 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1120 of the illustrated example, thus, typically includes a graphics driver card, a graphics driver chip, and/or graphics processor circuitry such as a GPU.

The interface circuitry 1120 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1126. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1100 of the illustrated example also includes one or more mass storage devices 1128 to store software and/or data. Examples of such mass storage devices 1128 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 1132, which may be implemented by the machine readable instructions of FIG. 9, may be stored in the mass storage device 1128, in the volatile memory 1114, in the non-volatile memory 1116, and/or on a removable non-transitory computer readable storage medium such as a CD or DVD.

FIG. 12 is a block diagram of an example implementation of the processor circuitry 1012 of FIG. 10 and/or the processor circuitry 1112 of FIG. 11. In this example, the processor circuitry 1012 of FIG. 10 and/or the processor circuitry 1112 of FIG. 11 is/are implemented by a microprocessor 1200. For example, the microprocessor 1200 may be a general purpose microprocessor (e.g., general purpose microprocessor circuitry). The microprocessor 1200 executes some or all of the machine readable instructions of the flowcharts of FIGS. 8 and 9 to effectively instantiate the circuitry of FIGS. 2 and 3, respectively, as logic circuits to perform the operations corresponding to those machine readable instructions. In some such examples, the circuitry of FIGS. 2 and 3 is/are instantiated by the hardware circuits of the microprocessor 1200 in combination with the instructions. For example, the microprocessor 1200 may be implemented by multi-core hardware circuitry such as a CPU, a DSP, a GPU, an XPU, etc. Although it may include any number of example cores 1202 (e.g., 1 core), the microprocessor 1200 of this example is a multi-core semiconductor device including N cores. The cores 1202 of the microprocessor 1200 may operate independently or may cooperate to execute machine readable instructions. For example, machine code corresponding to a firmware program, an embedded software program, or a software program may be executed by one of the cores 1202 or may be executed by multiple ones of the cores 1202 at the same or different times. In some examples, the machine code corresponding to the firmware program, the embedded software program, or the software program is split into threads and executed in parallel by two or more of the cores 1202. The software program may correspond to a portion or all of the machine readable instructions and/or operations represented by the flowcharts of FIGS. 8 and 9.

The cores 1202 may communicate by a first example bus 1204. In some examples, the first bus 1204 may be implemented by a communication bus to effectuate communication associated with one(s) of the cores 1202. For example, the first bus 1204 may be implemented by at least one of an Inter-Integrated Circuit (I2C) bus, a Serial Peripheral Interface (SPI) bus, a PCI bus, or a PCIe bus. Additionally or alternatively, the first bus 1204 may be implemented by any other type of computing or electrical bus. The cores 1202 may obtain data, instructions, and/or signals from one or more external devices by example interface circuitry 1206. The cores 1202 may output data, instructions, and/or signals to the one or more external devices by the interface circuitry 1206. Although the cores 1202 of this example include example local memory 1220 (e.g., Level 1 (L1) cache that may be split into an L1 data cache and an L1 instruction cache), the microprocessor 1200 also includes example shared memory 1210 that may be shared by the cores (e.g., Level 2 (L2 cache)) for high-speed access to data and/or instructions. Data and/or instructions may be transferred (e.g., shared) by writing to and/or reading from the shared memory 1210. The local memory 1220 of each of the cores 1202 and the shared memory 1210 may be part of a hierarchy of storage devices including multiple levels of cache memory and the main memory (e.g., the main memory 1014, 1016 of FIG. 10, the main memory 1114, 1116 of FIG. 11, etc.). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1202 may be referred to as a CPU, DSP, GPU, etc., or any other type of hardware circuitry. Each core 1202 includes control unit circuitry 1214, arithmetic and logic (AL) circuitry (sometimes referred to as an ALU) 1216, a plurality of registers 1218, the local memory 1220, and a second example bus 1222. Other structures may be present. For example, each core 1202 may include vector unit circuitry, single instruction multiple data (SIMD) unit circuitry, load/store unit (LSU) circuitry, branch/jump unit circuitry, floating-point unit (FPU) circuitry, etc. The control unit circuitry 1214 includes semiconductor-based circuits structured to control (e.g., coordinate) data movement within the corresponding core 1202. The AL circuitry 1216 includes semiconductor-based circuits structured to perform one or more mathematic and/or logic operations on the data within the corresponding core 1202. The AL circuitry 1216 of some examples performs integer based operations. In other examples, the AL circuitry 1216 also performs floating point operations. In yet other examples, the AL circuitry 1216 may include first AL circuitry that performs integer based operations and second AL circuitry that performs floating point operations. In some examples, the AL circuitry 1216 may be referred to as an Arithmetic Logic Unit (ALU). The registers 1218 are semiconductor-based structures to store data and/or instructions such as results of one or more of the operations performed by the AL circuitry 1216 of the corresponding core 1202. For example, the registers 1218 may include vector register(s), SIMD register(s), general purpose register(s), flag register(s), segment register(s), machine specific register(s), instruction pointer register(s), control register(s), debug register(s), memory management register(s), machine check register(s), etc. The registers 1218 may be arranged in a bank as shown in FIG. 12. Alternatively, the registers 1218 may be organized in any other arrangement, format, or structure including distributed throughout the core 1202 to shorten access time. The second bus 1222 may be implemented by at least one of an I2C bus, a SPI bus, a PCI bus, or a PCIe bus.

Each core 1202 and/or, more generally, the microprocessor 1200 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1200 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 13 is a block diagram of another example implementation of the processor circuitry 1012 of FIG. 10 and/or the processor circuitry 1112 of FIG. 11. In this example, the processor circuitry 1012 of FIG. 10 and/or the processor circuitry 1112 of FIG. 11 is/are implemented by FPGA circuitry 1300. For example, the FPGA circuitry 1300 may be implemented by an FPGA. The FPGA circuitry 1300 can be used, for example, to perform operations that could otherwise be performed by the example microprocessor 1200 of FIG. 12 executing corresponding machine readable instructions. However, once configured, the FPGA circuitry 1300 instantiates the machine readable instructions in hardware and, thus, can often execute the operations faster than they could be performed by a general purpose microprocessor executing the corresponding software.

More specifically, in contrast to the microprocessor 1200 of FIG. 12 described above (which is a general purpose device that may be programmed to execute some or all of the machine readable instructions represented by the flowcharts of FIGS. 8 and 9 but whose interconnections and logic circuitry are fixed once fabricated), the FPGA circuitry 1300 of the example of FIG. 13 includes interconnections and logic circuitry that may be configured and/or interconnected in different ways after fabrication to instantiate, for example, some or all of the machine readable instructions represented by the flowcharts of FIGS. 8 and/or 9. In particular, the FPGA circuitry 1300 may be thought of as an array of logic gates, interconnections, and switches. The switches can be programmed to change how the logic gates are interconnected by the interconnections, effectively forming one or more dedicated logic circuits (unless and until the FPGA circuitry 1300 is reprogrammed). The configured logic circuits enable the logic gates to cooperate in different ways to perform different operations on data received by input circuitry. Those operations may correspond to some or all of the software represented by the flowcharts of FIGS. 8 and/or 9. As such, the FPGA circuitry 1300 may be structured to effectively instantiate some or all of the machine readable instructions of the flowcharts of FIGS. 8 and/or 9 as dedicated logic circuits to perform the operations corresponding to those software instructions in a dedicated manner analogous to an ASIC. Therefore, the FPGA circuitry 1300 may perform the operations corresponding to the some or all of the machine readable instructions of FIGS. 8 and/or 9 faster than the general purpose microprocessor can execute the same.

In the example of FIG. 13, the FPGA circuitry 1300 is structured to be programmed (and/or reprogrammed one or more times) by an end user by a hardware description language (HDL) such as Verilog. The FPGA circuitry 1300 of FIG. 13, includes example input/output (I/O) circuitry 1302 to obtain and/or output data to/from example configuration circuitry 1304 and/or external hardware 1306. For example, the configuration circuitry 1304 may be implemented by interface circuitry that may obtain machine readable instructions to configure the FPGA circuitry 1300, or portion(s) thereof. In some such examples, the configuration circuitry 1304 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1306 may be implemented by external hardware circuitry. For example, the external hardware 1306 may be implemented by the microprocessor 1200 of FIG. 12. The FPGA circuitry 1300 also includes an array of example logic gate circuitry 1308, a plurality of example configurable interconnections 1310, and example storage circuitry 1312. The logic gate circuitry 1308 and the configurable interconnections 1310 are configurable to instantiate one or more operations that may correspond to at least some of the machine readable instructions of FIG. ______ and/or other desired operations. The logic gate circuitry 1308 shown in FIG. 13 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1308 to enable configuration of the electrical structures and/or the logic gates to form circuits to perform desired operations. The logic gate circuitry 1308 may include other electrical structures such as look-up tables (LUTs), registers (e.g., flip-flops or latches), multiplexers, etc.

The configurable interconnections 1310 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1308 to program desired logic circuits.

The storage circuitry 1312 of the illustrated example is structured to store result(s) of the one or more of the operations performed by corresponding logic gates. The storage circuitry 1312 may be implemented by registers or the like. In the illustrated example, the storage circuitry 1312 is distributed amongst the logic gate circuitry 1308 to facilitate access and increase execution speed.

The example FPGA circuitry 1300 of FIG. 13 also includes example Dedicated Operations Circuitry 1314. In this example, the Dedicated Operations Circuitry 1314 includes special purpose circuitry 1316 that may be invoked to implement commonly used functions to avoid the need to program those functions in the field. Examples of such special purpose circuitry 1316 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1300 may also include example general purpose programmable circuitry 1318 such as an example CPU 1320 and/or an example DSP 1322. Other general purpose programmable circuitry 1318 may additionally or alternatively be present such as a GPU, an XPU, etc., that can be programmed to perform other operations.

Although FIGS. 12 and 13 illustrate two example implementations of the processor circuitry 1012 of FIG. 10 and/or the processor circuitry 1112 of FIG. 11, many other approaches are contemplated. For example, as mentioned above, modern FPGA circuitry may include an on-board CPU, such as one or more of the example CPU 1320 of FIG. 13. Therefore, the processor circuitry 1012 of FIG. 10 and/or the processor circuitry 1112 of FIG. 11 may additionally be implemented by combining the example microprocessor 1200 of FIG. 12 and the example FPGA circuitry 1300 of FIG. 13. In some such hybrid examples, a first portion of the machine readable instructions represented by the flowcharts of FIGS. 8 and/or 9 may be executed by one or more of the cores 1202 of FIG. 12, a second portion of the machine readable instructions represented by the flowcharts of FIGS. 8 and/or 9 may be executed by the FPGA circuitry 1300 of FIG. 13, and/or a third portion of the machine readable instructions represented by the flowcharts of FIGS. 8 and/or 9 may be executed by an ASIC. It should be understood that some or all of the circuitry of FIG. 2 may, thus, be instantiated at the same or different times. Some or all of the circuitry may be instantiated, for example, in one or more threads executing concurrently and/or in series. Moreover, in some examples, some or all of the circuitry of FIGS. 2 and/or 3 may be implemented within one or more virtual machines and/or containers executing on the microprocessor.

In some examples, the processor circuitry 1012 of FIG. 10 and/or the processor circuitry 1112 of FIG. 11 may be in one or more packages. For example, the microprocessor 1200 of FIG. 12 and/or the FPGA circuitry 1300 of FIG. 13 may be in one or more packages. In some examples, an XPU may be implemented by the processor circuitry 1012 of FIG. 10 and/or the processor circuitry 1112 of FIG. 11, which may be in one or more packages. For example, the XPU may include a CPU in one package, a DSP in another package, a GPU in yet another package, and an FPGA in still yet another package.

From the foregoing, it will be appreciated that example systems, methods, apparatus, and articles of manufacture have been disclosed that identify vocal effort in audio data including speech. Disclosed systems, methods, apparatus, and articles of manufacture improve the efficiency of using a computing device by generating metadata from speech that can be used to annotate generated text with appropriate context and punctuation. These annotations to text improve a reader's ability to understand the message intended to be conveyed. Disclosed systems, methods, apparatus, and articles of manufacture are accordingly directed to one or more improvement(s) in the operation of a machine such as a computer or other electronic and/or mechanical device.

Example methods, apparatus, systems, and articles of manufacture for real-time voice type detection in audio data are disclosed herein. Further examples and combinations thereof include the following:

Example 1 includes a non-transitory computer-readable medium comprising instructions, which when executed, cause one or more processors to at least identify a first vocal effort of a first audio segment of first audio data and a second vocal effort of a second audio segment of the first audio data, train a neural network including training data, the training data including the first vocal effort, the first audio segment, the second audio segment, and the second vocal effort, and deploy the neural network, the neural network to distinguish between the first vocal effort and the second vocal effort.

Example 2 includes the non-transitory computer-readable medium of example 1, wherein the instructions, when executed, cause the one or more processors further to preprocess the first audio segment by extracting linear predictive coefficients from the first audio segment, the linear predictive coefficients including a time-frequency representation of the first audio segment.

Example 3 includes the non-transitory computer-readable medium of example 1, wherein the training data further includes a third audio segment including a regular vocal effort, a fourth audio segment including a loud vocal effort, and a fifth audio segment including a yelled vocal effort.

Example 4 includes the non-transitory computer-readable medium of example 1, wherein the instructions, when executed, cause the one or more processors further to analyze, via the neural network, a third audio segment to determine a third vocal effort of the third audio segment, and output, via the neural network, metadata including an indication corresponding to the third vocal effort, the indication having a first value when the third vocal effort is a whispered vocal effort, the indication having a second value when the third vocal effort is a soft vocal effort, the indication having a third value when the third vocal effort is neither the soft vocal effort or the whispered vocal effort.

Example 5 includes the non-transitory computer-readable medium of example 4, wherein the instructions, when executed, cause the one or more processors further to divide second audio data into a plurality of audio segments including the third audio segment, and wherein the metadata further includes a timestamp of the third audio segment within the second audio data, the timestamp associated with the indication.

Example 6 includes the non-transitory computer-readable medium of example 1, wherein the neural network is a feed-forward fully layered neural network.

Example 7 includes the non-transitory computer-readable medium of example 1, wherein the identification of the first vocal effort includes identifying a presence of harmonics indicative of a whispered vocal effort in the first audio segment and the identification of the second vocal effort including identifying an absence of harmonics indicative of a soft vocal effort in the second audio segment.

Example 8 includes an apparatus audio interface circuitry, and one or more processors to execute instructions to identify a first vocal effort of a first audio segment of first audio data and a second vocal effort of a second audio segment of the first audio data, train a neural network including training data, the training data including the first vocal effort, the first audio segment, the second audio segment, and the second vocal effort, and deploy the neural network, the neural network to distinguish between the first vocal effort and the second vocal effort.

Example 9 includes the apparatus of example 8, wherein the one or more processors executes the instructions to preprocess the first audio segment by extracting linear predictive coefficients from the first audio segment, the linear predictive coefficients including a time-frequency representation of the first audio segment.

Example 10 includes the apparatus of example 8, wherein the training data further includes a third audio segment including a regular vocal effort, a fourth audio segment including a loud vocal effort, and a fifth audio segment including a yelled vocal effort.

Example 11 includes the apparatus of example 8, wherein the one or more processors executes the instructions to analyze, via the neural network, a third audio segment to determine a third vocal effort of the third audio segment, and output, via the neural network, metadata including an indication corresponding to the third vocal effort, the indication having a first value when the third vocal effort is a whispered vocal effort, the indication having a second value when the third vocal effort is a soft vocal effort, the indication having a third value when the third vocal effort is neither the soft vocal effort or the whispered vocal effort.

Example 12 includes the apparatus of example 11, wherein the one or more processors executes the instructions to divide second audio data into a plurality of audio segments including the third audio segment, and wherein the metadata further includes a timestamp of the third audio segment within the second audio data, the timestamp associated with the indication.

Example 13 includes the apparatus of example 8, wherein the neural network is a feed-forward fully layered neural network.

Example 14 includes the apparatus of example 8, wherein the one or more processors executes the instructions to identify the first vocal effort by identifying a presence of harmonics indicative of a whispered vocal effort in the first audio segment and the identification of the second vocal effort including identifying an absence of harmonics indicative of a soft vocal effort in the second audio segment.

Example 15 includes a method comprising identifying a first vocal effort of a first audio segment of first audio data and a second vocal effort of a second audio segment of the first audio data, training a neural network including training data, the training data including the first vocal effort, the first audio segment, the second audio segment, and the second vocal effort, and deploying the neural network, the neural network to distinguish between the first vocal effort and the second vocal effort.

Example 16 includes the method of example 15, further including preprocessing the first audio segment by extracting linear predictive coefficients from the first audio segment, the linear predictive coefficients including a time-frequency representation of the first audio segment.

Example 17 includes the method of example 15, wherein the training data further includes a third audio segment including a regular vocal effort, a fourth audio segment including a loud vocal effort, and a fifth audio segment including a yelled vocal effort.

Example 18 includes the method of example 15, further including analyze, via the neural network, a third audio segment to determine a third vocal effort of the third audio segment, and output, via the neural network, metadata including an indication corresponding to the third vocal effort, the indication having a first value when the third vocal effort is a whispered vocal effort, the indication having a second value when the third vocal effort is a soft vocal effort, the indication having a third value when the third vocal effort is neither the soft vocal effort or the whispered vocal effort.

Example 19 includes the method of example 17, further including dividing second audio data into a plurality of audio segments including the third audio segment, and wherein the metadata further includes a timestamp of the third audio segment within the second audio data, the timestamp associated with the indication.

Example 20 includes the method of example 15, wherein the identification of the first vocal effort includes identifying a presence of harmonics indicative of a whispered vocal effort in the first audio segment and the identification of the second vocal effort including identifying an absence of harmonics indicative of a soft vocal effort in the second audio segment.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

What is claimed is:

1. A non-transitory computer-readable medium comprising instructions, which when executed, cause one or more processors to at least:
identify a first vocal effort of a first audio segment of first audio data and a second vocal effort of a second audio segment of the first audio data;
train a neural network including training data, the training data including the first vocal effort, the first audio segment, the second audio segment, and the second vocal effort; and
deploy the neural network, the neural network to distinguish between the first vocal effort and the second vocal effort.

2. The non-transitory computer-readable medium of claim 1, wherein the instructions, when executed, cause the one or more processors further to preprocess the first audio segment by extracting linear predictive coefficients from the first audio segment, the linear predictive coefficients including a time-frequency representation of the first audio segment.

3. The non-transitory computer-readable medium of claim 1, wherein the training data further includes a third audio segment including a regular vocal effort, a fourth audio segment including a loud vocal effort, and a fifth audio segment including a yelled vocal effort.

4. The non-transitory computer-readable medium of claim 1, wherein the instructions, when executed, cause the one or more processors further to:
analyze, via the neural network, a third audio segment to determine a third vocal effort of the third audio segment; and
output, via the neural network, metadata including an indication corresponding to the third vocal effort, the indication having a first value when the third vocal effort is a whispered vocal effort, the indication having a second value when the third vocal effort is a soft vocal effort, the indication having a third value when the third vocal effort is neither the soft vocal effort or the whispered vocal effort.

5. The non-transitory computer-readable medium of claim 4, wherein the instructions, when executed, cause the one or more processors further to divide second audio data into a plurality of audio segments including the third audio segment, and wherein the metadata further includes a timestamp of the third audio segment within the second audio data, the timestamp associated with the indication.

6. The non-transitory computer-readable medium of claim 1, wherein the neural network is a feed-forward fully layered neural network.

7. The non-transitory computer-readable medium of claim 1, wherein the identification of the first vocal effort includes identifying a presence of harmonics indicative of a whispered vocal effort in the first audio segment and the identification of the second vocal effort including identifying an absence of harmonics indicative of a soft vocal effort in the second audio segment.

8. An apparatus:
audio interface circuitry; and
one or more processors to execute instructions to:
identify a first vocal effort of a first audio segment of first audio data and a second vocal effort of a second audio segment of the first audio data;
train a neural network including training data, the training data including the first vocal effort, the first audio segment, the second audio segment, and the second vocal effort; and
deploy the neural network, the neural network to distinguish between the first vocal effort and the second vocal effort.

9. The apparatus of claim 8, wherein the one or more processors executes the instructions to preprocess the first audio segment by extracting linear predictive coefficients from the first audio segment, the linear predictive coefficients including a time-frequency representation of the first audio segment.

10. The apparatus of claim 8, wherein the training data further includes a third audio segment including a regular vocal effort, a fourth audio segment including a loud vocal effort, and a fifth audio segment including a yelled vocal effort.

11. The apparatus of claim 8, wherein the one or more processors executes the instructions to:
analyze, via the neural network, a third audio segment to determine a third vocal effort of the third audio segment; and
output, via the neural network, metadata including an indication corresponding to the third vocal effort, the indication having a first value when the third vocal effort is a whispered vocal effort, the indication having a second value when the third vocal effort is a soft vocal effort, the indication having a third value when the third vocal effort is neither the soft vocal effort or the whispered vocal effort.

12. The apparatus of claim 11, wherein the one or more processors executes the instructions to divide second audio data into a plurality of audio segments including the third audio segment, and wherein the metadata further includes a timestamp of the third audio segment within the second audio data, the timestamp associated with the indication.

13. The apparatus of claim 8, wherein the neural network is a feed-forward fully layered neural network.

14. The apparatus of claim 8, wherein the one or more processors executes the instructions to identify the first vocal effort by identifying a presence of harmonics indicative of a whispered vocal effort in the first audio segment and the identification of the second vocal effort including identifying an absence of harmonics indicative of a soft vocal effort in the second audio segment.

15. A method comprising:
identifying a first vocal effort of a first audio segment of first audio data and a second vocal effort of a second audio segment of the first audio data;
training a neural network including training data, the training data including the first vocal effort, the first audio segment, the second audio segment, and the second vocal effort; and
deploying the neural network, the neural network to distinguish between the first vocal effort and the second vocal effort.

16. The method of claim 15, further including preprocessing the first audio segment by extracting linear predictive coefficients from the first audio segment, the linear predictive coefficients including a time-frequency representation of the first audio segment.

17. The method of claim 15, wherein the training data further includes a third audio segment including a regular vocal effort, a fourth audio segment including a loud vocal effort, and a fifth audio segment including a yelled vocal effort.

18. The method of claim 15, further including:
analyze, via the neural network, a third audio segment to determine a third vocal effort of the third audio segment; and
output, via the neural network, metadata including an indication corresponding to the third vocal effort, the indication having a first value when the third vocal effort is a whispered vocal effort, the indication having a second value when the third vocal effort is a soft vocal effort, the indication having a third value when the third vocal effort is neither the soft vocal effort or the whispered vocal effort.

19. The method of claim 18, further including dividing second audio data into a plurality of audio segments including the third audio segment, and wherein the metadata further includes a timestamp of the third audio segment within the second audio data, the timestamp associated with the indication.

20. The method of claim 15, wherein the identification of the first vocal effort includes identifying a presence of harmonics indicative of a whispered vocal effort in the first audio segment and the identification of the second vocal effort including identifying an absence of harmonics indicative of a soft vocal effort in the second audio segment.
